(19) United States
(12) Patent Application Publication
(10) Pub. No.: US 2026/0332053 A1
(43) Pub. Date: Oct. 22, 2026

(54) ELECTRICAL EQUIPMENT DEVICE, DISPLAY DEVICE, AND POWER SUPPLY DEVICE

(71) Applicant: SONY GROUP CORPORATION, TOKYO (JP)

(72) Inventors: HIROTAKA NONAKA, TOKYO (JP); MASANOBU TAKAHAMA, TOKYO (JP); HIROMI KOMIYA, TOKYO (JP)

(21) Appl. No.: 19/114,078

(22) PCT Filed: Sep. 20, 2023
(86) PCT No.: PCT/JP2023/034030

§ 371 Date: Mar. 21, 2025

(30) Foreign Application Priority Data
Sep. 28, 2022 (JP) 2022-154493

(51) Int. Cl. H02M 3/28; H02M 1/42

(52) U.S. Cl. CPC H02M 3/28; H02M 1/4208

(57) ABSTRACT

To improve efficiency of a power supply device by suppressing a power loss when load power decreases.

There are provided: a first power conversion unit being of an insulation type and configured to be input with a DC input voltage to obtain a first power supply output of a DC voltage having a first value; a second power conversion unit being of an insulation type and configured to be input with the DC input voltage to obtain a second power supply output of a DC voltage having a second value different from the first value; and a third power conversion unit being of a non-insulation type and configured to be input with the DC voltage obtained by the second power conversion unit and having the second value to obtain a third power supply output of a DC voltage having the first value. In a second mode (light load mode) in which load power of a first load unit is equal to or less than a threshold, the third power supply output is output from a switching unit and supplied to the first load unit, and it becomes possible to improve efficiency of a power supply device by suppressing a power loss when load power decreases.

### TECHNICAL FIELD

The present technology relates to an electrical equipment device, a display device, and a power supply device, and more particularly to an electrical equipment device and the like capable of suppressing loss power generated in the power supply device.

### BACKGROUND ART

For example, Patent Document 1 describes a power supply device in which two insulation power supply circuits having different power ratings are provided in parallel, and a power loss can be suppressed by switching to the insulation power supply circuit having a smaller power rating when a load becomes small.

### CITATION LIST

### Patent Document

Patent Document 1: Japanese Patent Application Laid-Open No. 2007-104409

### SUMMARY OF THE INVENTION

### Problems to be Solved by the Invention

An object of the present technology is to improve efficiency of a power supply device by suppressing a power loss when load power decreases.

### Solutions to Problems

A concept of the present technology is in an electrical equipment device including:
a first load unit;
a second load unit; and
a power supply device, in which
the power supply device includes:
an input voltage generation unit configured to be input with a commercial AC power supply to generate a DC input voltage;
a first power conversion unit being of an insulation type and configured to be input with the DC input voltage to obtain a first power supply output of a DC voltage having a first value;
a second power conversion unit being of an insulation type and configured to be input with the DC input voltage to obtain a second power supply output of a DC voltage having a second value different from the first value;
a third power conversion unit being of a non-insulation type and configured to be input with the DC voltage having the second value to obtain a third power supply output of a DC voltage having the first value;
a switching unit configured to selectively output the first power supply output or the third power supply output;

a power supply output supply unit configured to supply a power supply output that is output from the switching unit to the first load unit, and supply the second power supply output to the second load unit; and
a control unit configured to cause the switching unit to output the first power supply output in a first mode in which load power of the first load unit is larger than a threshold, and cause the switching unit to output the third power supply output in a second mode in which load power of the first load unit is equal to or less than the threshold.

The electrical equipment device according to the present technology includes the first load unit, the second load unit, and the power supply device. Here, required voltage values are different between the first load unit and the second load unit.

The power supply device includes the input voltage generation unit, the first power conversion unit, the second power conversion unit, the third power conversion unit, the switching unit, the power supply output supply unit, and the control unit.

In the input voltage generation unit, a commercial AC power supply is input, and a DC input voltage is generated. The first power conversion unit is of an insulation type, and the first power conversion unit is input with the DC input voltage generated by the input voltage generation unit to obtain a first power supply output of a DC voltage having a first value. The second power conversion unit is of an insulation type, and the second power conversion unit is input with the DC input voltage generated by the input voltage generation unit to obtain a second power supply output of a DC voltage having a second value different from the first value. The third power conversion unit is a non-insulation system, and the third power conversion unit is inputted with the DC voltage having the second value obtained by the second power conversion unit to obtain a third power supply output of a DC voltage having the first value.

The switching unit selectively outputs the first power supply output obtained by the first power conversion unit or the third power supply output obtained by the third power conversion unit. The power supply output supply unit supplies a power supply output that is output from the switching unit to the first load unit, and supplies the second power supply output obtained by the second power conversion unit to the second load unit. The control unit is configured to cause the switching unit to output the first power supply output in a first mode (heavy load mode) in which load power of the first load unit is larger than the threshold, and cause the switching unit to output the third power supply output in a second mode (light load mode) in which load power of the first load unit is equal to or less than the threshold.

For example, the control unit may be configured to stop the third power conversion unit in the first mode, and stop the first power conversion unit in the second mode. In this case, for example, the switching unit may have a configuration in which a switching element, a diode, an AC relay, a photo MOSFET, or the like is disposed on each of a path between an output side and the first power conversion unit and a path between the output side and the third power conversion unit.

Furthermore, for example, the control unit may be configured to stop the first power conversion unit in the second mode. In this case, for example, the switching unit may have a configuration in which two MOSFETs are disposed in series such that directions of parasitic diodes are opposite to each other on a path between an output side and the third power conversion unit, or a configuration in which an AC relay, a photo MOSFET, or the like is disposed.

Furthermore, for example, the input voltage generation unit may include a rectification unit that rectifies the commercial AC power supply, and a fourth power conversion unit that is a step-up type and a non-insulation type and is input with an output voltage of the rectification unit to obtain a DC input voltage. In this case, for example, the control unit may be configured to stop a step-up operation of the fourth power conversion unit in the second mode. Furthermore, in this case, for example, the fourth power conversion unit may include a PFC circuit.

Furthermore, for example, the input voltage generation unit may include a fourth power conversion unit that is a step-up type and a non-insulation type and is input with the commercial AC power supply to obtain a DC input voltage. In this case, for example, the fourth power conversion unit may include a totem-pole PFC circuit. Furthermore, in this case, for example, a dual boost PFC circuit may be used.

Furthermore, for example, the first power conversion unit may include an LLC current resonant DC-DC converter or a flyback converter, the second power conversion unit may include an LLC current resonant DC-DC converter or a flyback converter, and the third power conversion unit may include a step-up DC-DC converter, a step-down DC-DC converter, or a step-up/down DC-DC converter.

Furthermore, for example, a user operation unit that allows a user to perform an operation for changing load power of the first load unit may be further included.

As described above, in the present technology, the power supply device includes: the first power conversion unit being of an insulation type and configured to be input with a DC input voltage to obtain a first power supply output of a DC voltage having a first value; the second power conversion unit being of an insulation type and configured to be input with the DC input voltage to obtain a second power supply output of a DC voltage having a second value different from the first value; and the third power conversion unit being of a non-insulation type and configured to be input with the DC voltage obtained by the second power conversion unit and having the second value to obtain a third power supply output of a DC voltage having the first value. In the second mode (light load mode) in which load power of the first load unit is equal to or less than a threshold, the third power supply output is output from the switching unit and supplied to the first load unit, and it becomes possible to improve efficiency of the power supply device by suppressing a power loss when load power decreases.

Another concept of the present technology is in a display device including:
a display unit;
a load unit different from the display unit; and
a power supply device, in which
the power supply device includes:
an input voltage generation unit configured to be input with a commercial AC power supply to generate a DC input voltage;
a first power conversion unit being of an insulation type and configured to be input with the DC input voltage to obtain a first power supply output of a DC voltage having a first value;
a second power conversion unit being of an insulation type and configured to be input with the DC input voltage to obtain a second power supply output of a DC voltage having a second value different from the first value;
a third power conversion unit being of a non-insulation type and configured to be input with the DC voltage having the second value to obtain a third power supply output of a DC voltage having the first value;
a switching unit configured to selectively output the first power supply output or the third power supply output;
a power supply output supply unit configured to supply a power supply output that is output from the switching unit to the display unit, and supply the second power supply output to the load unit; and
a control unit configured to cause the switching unit to output the first power supply output in a first mode in which load power of the display unit is larger than a threshold, and cause the switching unit to output the third power supply output in a second mode in which load power of the display unit is equal to or less than the threshold.

The display device of the present technology includes the display unit, the load unit different from the display unit, and the power supply device. Here, required voltage values are different between the display unit and the load unit. The power supply device includes the input voltage generation unit, the first power conversion unit, the second power conversion unit, the third power conversion unit, the switching unit, the power supply output supply unit, and the control unit.

In the input voltage generation unit, a commercial AC power supply is input, and a DC input voltage is generated. The first power conversion unit is of an insulation type, and the first power conversion unit is input with the DC input voltage generated by the input voltage generation unit to obtain a first power supply output of a DC voltage having a first value. The second power conversion unit is of an insulation type, and the second power conversion unit is input with the DC input voltage generated by the input voltage generation unit to obtain a second power supply output of a DC voltage having a second value different from the first value. The third power conversion unit is a non-insulation system, and the third power conversion unit is inputted with the DC voltage having the second value obtained by the second power conversion unit to obtain a third power supply output of a DC voltage having the first value.

The switching unit selectively outputs the first power supply output obtained by the first power conversion unit or the third power supply output obtained by the third power conversion unit. The power supply output supply unit supplies the power supply output that is output from the switching unit to the display unit, and supplies the second power supply output obtained by the second power conversion unit to a load unit different from the display unit. The control unit is configured to cause the switching unit to output the first power supply output in a first mode (heavy load mode) in which load power of the display unit is larger than the threshold, and cause the switching unit to output the third power supply output in a second mode (light load mode) in which load power of the display unit is equal to or less than the threshold.

For example, the display unit may be a liquid crystal panel having a backlight or an organic EL panel. Furthermore, for example, a user operation unit that allows a user to perform an operation for changing display luminance of the display unit may be further included, and load power of the display unit may change in accordance with a change in the display luminance.

As described above, in the present technology, the power supply device includes: the first power conversion unit being of an insulation type and configured to be input with a DC input voltage to obtain a first power supply output of a DC voltage having a first value; the second power conversion unit being of an insulation type and configured to be input with the DC input voltage to obtain a second power supply output of a DC voltage having a second value different from the first value; and the third power conversion unit being of a non-insulation type and configured to be input with the DC voltage obtained by the second power conversion unit and having the second value to obtain a third power supply output of a DC voltage having the first value. In the second mode (light load mode) in which load power of the display unit is equal to or less than a threshold, the third power supply output is output from the switching unit and supplied to the display unit, and it becomes possible to improve efficiency of the power supply device by suppressing a power loss when load power decreases.

Furthermore, still another concept of the present technology is in a power supply device including:
an input voltage generation unit configured to be input with a commercial AC power supply to generate a DC input voltage;
a first power conversion unit being of an insulation type and configured to be input with the DC input voltage to obtain a first power supply output of a DC voltage having a first value;
a second power conversion unit being of an insulation type and configured to be input with the DC input voltage to obtain a second power supply output of a DC voltage having a second value different from the first value;
a third power conversion unit being of a non-insulation type and configured to be input with the DC voltage having the second value to obtain a third power supply output of a DC voltage having the first value;
a switching unit configured to selectively output the first power supply output or the third power supply output;
a power supply output supply unit configured to supply a power supply output that is output from the switching unit to a first load unit, and supply the second power supply output to a second load unit; and
a control unit configured to cause the switching unit to output the first power supply output in a first mode in which load power of the first load unit is larger than a threshold, and cause the switching unit to output the third power supply output in a second mode in which load power of the first load unit is equal to or less than the threshold.

The power supply device of the present technology includes the input voltage generation unit, the first power conversion unit, the second power conversion unit, the third power conversion unit, the switching unit, the power supply output supply unit, and the control unit.

In the input voltage generation unit, a commercial AC power supply is input, and a DC input voltage is generated. The first power conversion unit is of an insulation type, and the first power conversion unit is input with the DC input voltage generated by the input voltage generation unit to obtain a first power supply output of a DC voltage having a first value. The second power conversion unit is of an insulation type, and the second power conversion unit is input with the DC input voltage generated by the input voltage generation unit to obtain a second power supply output of a DC voltage having a second value different from the first value. The third power conversion unit is a non-insulation system, and the third power conversion unit is inputted with the DC voltage having the second value obtained by the second power conversion unit to obtain a third power supply output of a DC voltage having the first value.

The switching unit selectively outputs the first power supply output obtained by the first power conversion unit or the third power supply output obtained by the third power conversion unit. The power supply output supply unit supplies a power supply output that is output from the switching unit to the first load unit, and supplies the second power supply output obtained by the second power conversion unit to the second load unit. The control unit is configured to cause the switching unit to output the first power supply output in a first mode (heavy load mode) in which load power of the first load unit is larger than the threshold, and cause the switching unit to output the third power supply output in a second mode (light load mode) in which load power of the first load unit is equal to or less than the threshold.

As described above, in the present technology, there are provided: the first power conversion unit being of an insulation type and configured to be input with a DC input voltage to obtain a first power supply output of a DC voltage having a first value; the second power conversion unit being of an insulation type and configured to be input with the DC input voltage to obtain a second power supply output of a DC voltage having a second value different from the first value; and the third power conversion unit being of a non-insulation type and configured to be input with the DC voltage obtained by the second power conversion unit and having the second value to obtain a third power supply output of a DC voltage having the first value. In the second mode (light load mode) in which load power of the first load unit is equal to or less than a threshold, the third power supply output is output from the switching unit and supplied to the first load unit, and it becomes possible to improve efficiency of the power supply device by suppressing a power loss when load power decreases.

### BRIEF DESCRIPTION OF DRAWINGS

FIG. 1 is a block diagram illustrating a configuration example of a power supply device.

FIG. 2 is a diagram illustrating a role and a function of each power supply circuit in the power supply device of FIG. 1.

FIG. 3 is a block diagram illustrating another configuration example of the power supply device.

FIG. 4 is a diagram illustrating a role and a function of each power supply circuit in the power supply device of FIG. 3.

FIG. 5 is a block diagram illustrating a configuration example of a TV monitor.

FIG. 6 is a block diagram illustrating a configuration example of a power supply device included in the TV monitor.

FIG. 7 is a diagram illustrating a role and a function of each power supply circuit in the power supply device of FIG. 6.

FIG. 8 is a diagram illustrating a configuration example of a PFC circuit (step-up DC-DC converter).

FIG. 9 is a diagram illustrating a configuration example of an LLC current resonant DC-DC converter.

FIG. 10 is a diagram illustrating a configuration example of a flyback converter.

FIG. 11 is a diagram schematically illustrating operations of a rectifier circuit, a power supply circuit, and the like in the power supply device of FIG. 6.

FIG. 12 is a diagram illustrating a configuration example of a step-up DC-DC converter.

FIG. 13 is a diagram illustrating a configuration example of a step-down DC-DC converter.

FIG. 14 is a diagram illustrating a configuration example of a step-up/down DC-DC converter.

FIG. 15 is a diagram illustrating an example of a configuration of a switching circuit in the power supply device of FIG. 6 and an outline of control by a control signal CS.

FIG. 16 is a flowchart illustrating an example of operation control performed by a CPU on a portion related to a power supply output A of the power supply device in the configuration example of FIG. 15.

FIG. 17 is a diagram illustrating another example of a configuration of the switching circuit in the power supply device of FIG. 6 and an outline of control by the control signal CS.

FIG. 18 is a flowchart illustrating an example of operation control performed by a CPU on a portion related to a power supply output A of the power supply device in the configuration example of FIG. 17.

FIG. 19 is a diagram illustrating still another example of a configuration of the switching circuit in the power supply device of FIG. 6 and an outline of control by the control signal CS.

FIG. 20 is a flowchart illustrating an example of operation control performed by a CPU on a portion related to a power supply output A of the power supply device in the configuration example of FIG. 19.

FIG. 21 is a block diagram illustrating another configuration example of the power supply device included in the TV monitor.

FIG. 22 is a diagram schematically illustrating an operation when a PFC circuit (step-up DC-DC converter) is in operation.

FIG. 23 is a diagram schematically illustrating an operation when the PFC circuit (step-up DC-DC converter) is stopped.

FIG. 24 is a diagram schematically illustrating operations of a rectifier circuit, a power supply circuit, and the like in the power supply device of FIG. 21.

FIG. 25 is a diagram schematically illustrating, by a bar chart, individual power circuits and the entire loss power in a case of a light load in each power supply device of FIGS. 1, 3, 6, and 21.

FIG. 26 is a diagram for comparing and explaining efficiencies of the power supply devices of FIGS. 1 and 6 at a time of a light load.

FIG. 27 is a block diagram illustrating still another configuration example of the power supply device included in the TV monitor.

FIG. 28 is a diagram illustrating a configuration example of a totem-pole PFC circuit.

FIG. 29 is a diagram illustrating a configuration example of a dual boost PFC circuit.

FIG. 30 is a block diagram illustrating a configuration example of a general electrical equipment device including the power supply device of the present technology.

### MODE FOR CARRYING OUT THE INVENTION

Hereinafter, a mode for carrying out the invention (hereinafter referred to as an “embodiment”) will be described. Note that the description will be made in the following order.
1. Embodiment
2. Modifications

### 1. Embodiment

### [Configuration Example of Power Supply Device]

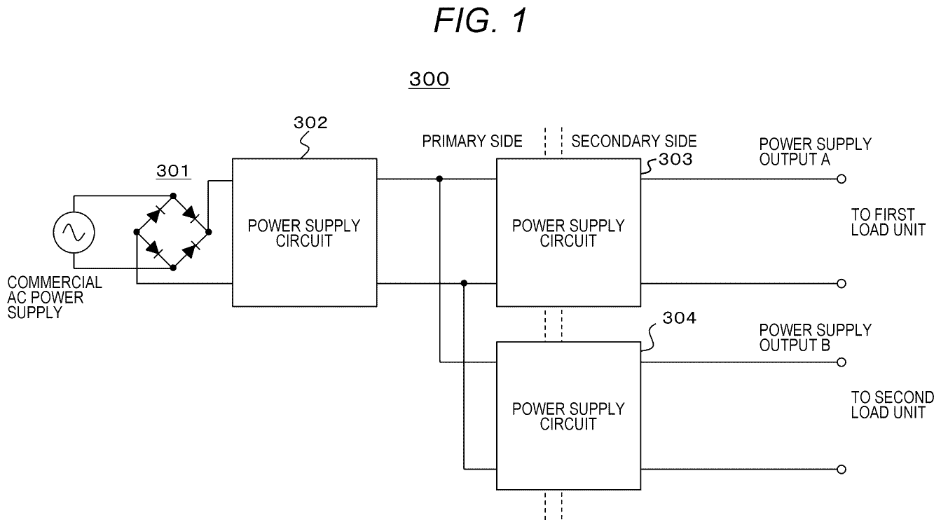

FIG. 1 illustrates a configuration example of a power supply device 300. The power supply device 300 includes a rectifier circuit 301, a power supply circuit 302, a power supply circuit 303, and a power supply circuit 304.

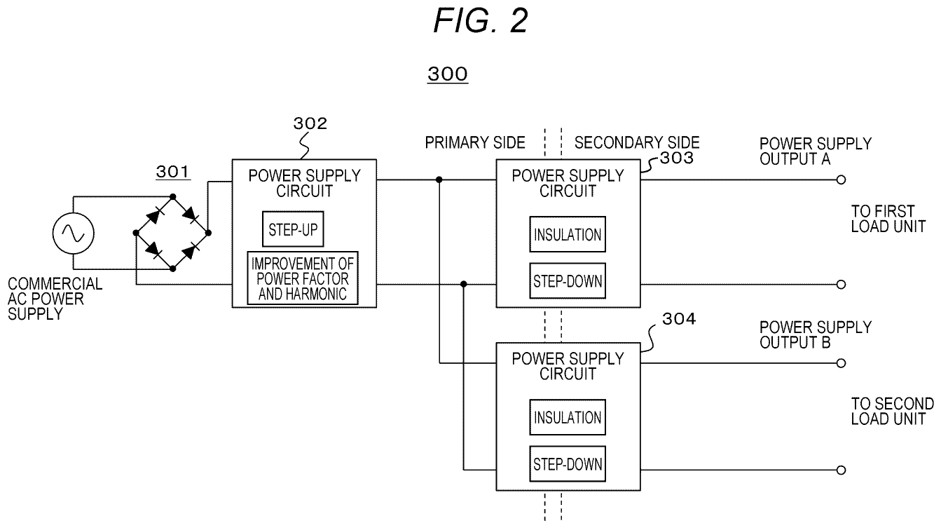

The rectifier circuit 301 rectifies an input commercial AC power supply. The rectifier circuit 301 is configured as, for example, a bridge rectifier circuit including four rectifier diodes as illustrated in the figure. The power supply circuit 302 constitutes a power conversion unit of a non-insulation type, and outputs a DC input voltage with an output of the rectifier circuit 301 as an input. As illustrated in FIG. 2, the power supply circuit 302 has functions of step-up and improving a power factor and a harmonic, and includes, for example, a power factor correction (PFC) circuit which is a step-up DC-DC converter.

The power supply circuit 303 constitutes a power conversion unit of an insulation type, and obtains a power supply output A of a DC voltage having a first value with an output of the power supply circuit 302 as an input. As illustrated in FIG. 2, the power supply circuit 303 has functions of insulation and step-down, and includes, for example, an LLC current resonant converter, a flyback converter, or the like. The power supply output A obtained by the power supply circuit 303 is supplied to a first load unit.

The power supply circuit 304 constitutes a power conversion unit of an insulation type, and obtains a power supply output B of a DC voltage having a second value different from the first value, with an output of the power supply circuit 302 as an input. Similarly to the power supply circuit 302 described above, as illustrated in FIG. 2, the power supply circuit 303 has functions of insulation and step-down, and includes, for example, an LLC current resonant converter, a flyback converter, or the like. The power supply output A obtained by the power supply circuit 303 is supplied to a first load unit.

The reason why the power supply circuit is divided into the power supply circuit 303 and the power supply circuit 304 in this manner is that voltage values required for the first load unit and the second load unit are different. That is, a voltage value required by the first load unit is the first value, and a voltage value required by the second load unit is the second value.

In the case of the power supply device 300 illustrated in FIG. 1, the power supply output A is supplied from the power supply circuit 303 to the first load unit even at a time of a light load in which load power decreases. Therefore, there is a problem that a power supply efficiency decreases due to a power loss in the power supply circuit 303.

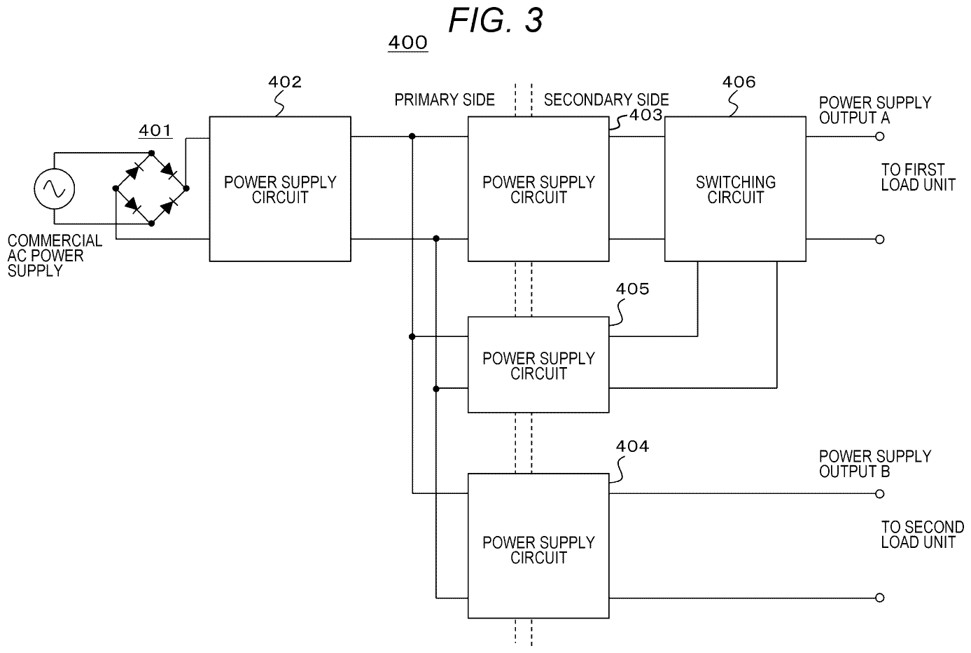

FIG. 3 illustrates a configuration example of a power supply device 400. The power supply device 400 corresponds to a power supply device described in Cited Document 1 described above. The power supply device 400 includes a rectifier circuit 401, a power supply circuit 402, a power supply circuit 403, a power supply circuit 404, a power supply circuit 405, and a switching circuit 406.

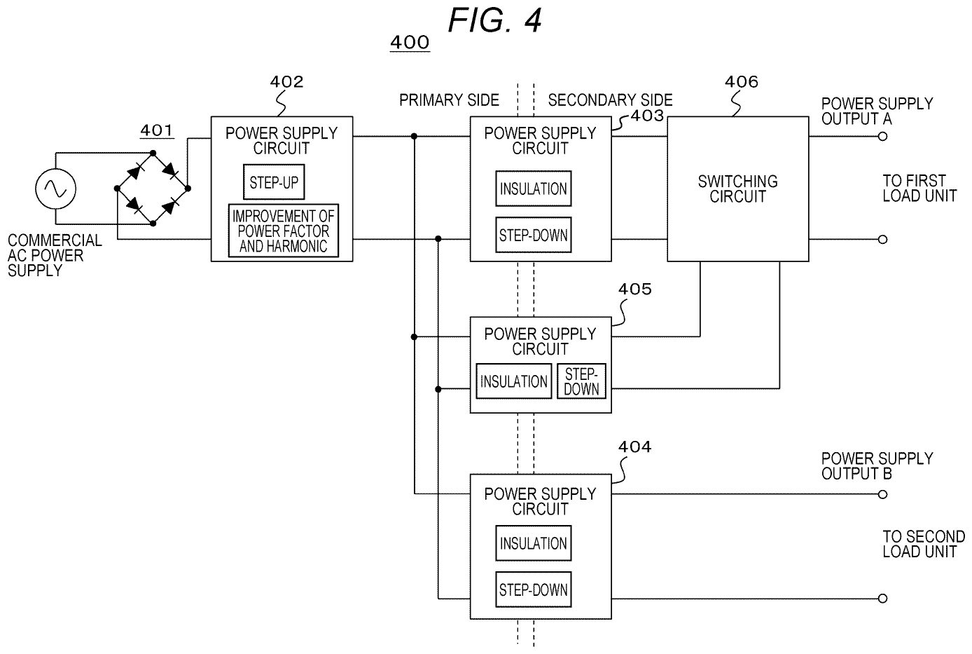

The rectifier circuit 401 rectifies an input commercial AC power supply. The rectifier circuit 401 is configured as, for example, a bridge rectifier circuit including four rectifier diodes as illustrated in the figure. The power supply circuit 402 constitutes a power conversion unit of a non-insulation type, and outputs a DC input voltage with an output of the rectifier circuit 401 as an input. As illustrated in FIG. 4, the power supply circuit 402 has functions of step-up and improving a power factor and a harmonic, and includes, for example, a power factor correction (PFC) circuit which is a step-up DC-DC converter.

The power supply circuit 403 constitutes a power conversion unit of an insulation type, and obtains a power supply output of a DC voltage having the first value with an output of the power supply circuit 402 as an input. As illustrated in FIG. 4, the power supply circuit 403 has functions of insulation and step-down, and includes, for example, an LLC current resonant converter, a flyback converter, or the like.

The power supply circuit 404 constitutes a power conversion unit of an insulation type, and obtains a power supply output B of a DC voltage having a second value different from the first value, with an output of the power supply circuit 402 as an input. Similarly to the power supply circuit 403 described above, as illustrated in FIG. 4, the power supply circuit 404 has functions of insulation and step-down, and includes, for example, an LLC current resonant converter, a flyback converter, or the like. The power supply output B obtained by the power supply circuit 404 is supplied to the second load unit.

The power supply circuit 405 constitutes a power conversion unit of an insulation type, and obtains a power supply output of a DC voltage having a first value with an output of the power supply circuit 402 as an input, similarly to the power supply circuit 403 described above. As illustrated in FIG. 4, the power supply circuit 405 has functions of insulation and step-down, and includes, for example, an LLC current resonant converter, a flyback converter, or the like. A power rating of the power supply circuit 405 is made lower than a power rating of the power supply circuit 403.

The switching circuit 406 selectively outputs the power supply output of the power supply circuit 403 or the power supply output of the power supply circuit 405, as a power supply output A. This power supply output A is supplied to the first load unit.

In a case where load power of the first load unit is in a large heavy load, the power supply circuit 403 is set to an operating state (the power supply circuit 405 is in a stopped state), and the power supply output obtained by the power supply circuit 403 is output as the power supply output A in the switching circuit 406. Whereas, in a case where load power of the first load unit is in a small light load, the power supply circuit 405 is set to an operating state (the power supply circuit 403 is in a stopped state), and the power supply output obtained by the power supply circuit 405 is output as the power supply output A in the switching circuit 406.

In the case of the power supply device 400 illustrated in FIG. 3, switching is performed such that, to the first load unit to which the power supply output A is supplied, the power supply output A is supplied from the power supply circuit 405 having a small power rating at the time of a light load in which load power of the first load unit decreases, so that the power loss can be reduced and the power supply efficiency can be increased as compared with the power supply device 300 illustrated in FIG. 1. However, since the power supply circuit 405 of the insulation type is used, there is a problem that a power loss corresponding to an insulation transformer occurs and the power supply efficiency is lowered accordingly.

### “Configuration Example of TV Monitor”

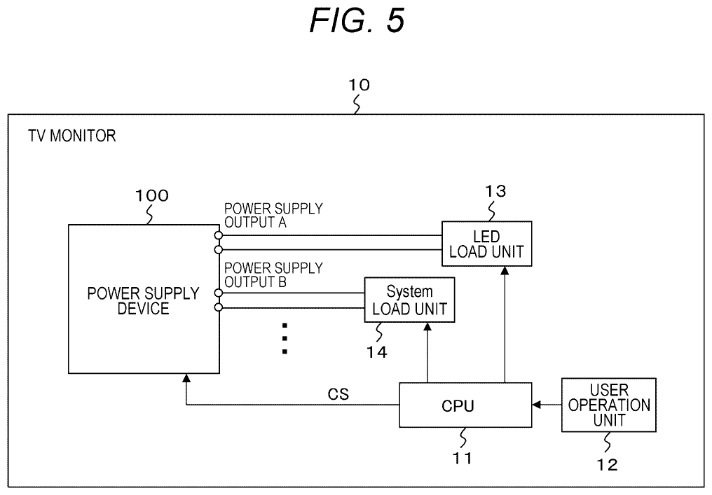

FIG. 5 illustrates a configuration example of a TV monitor 10 as an embodiment. The TV monitor 10 includes a central processing unit (CPU) 11, a user operation unit 12, an LED load unit 13, a system load unit 14, and a power supply device 100.

The CPU 11 constitutes a control unit that entirely controls the TV monitor 10. The user operation unit 12 receives various operations of a user, and transmits an operation signal to the CPU 11. The LED load unit 13 means a display unit including, for example, a liquid crystal panel having a backlight of a light emitting diode (LED) or an organic electronic luminescent (EL) panel. The system load unit 14 includes a video or audio signal processing circuit, a speaker drive circuit, a liquid crystal drive circuit, and the like.

Note that, in the illustrated example, only two of the LED load unit 13 and the system load unit 14 are illustrated, and illustration of other load units is omitted for simplification of description.

Load power of the LED load unit 13 is, for example, several 10 W to several 100 W. In this case, for example, when the user performs an operation of changing display luminance in image quality setting from the user operation unit 12, the display luminance in the LED load unit 13 is changed under the control of the CPU 11, and load power of the LED load unit 13 changes accordingly. For example, the load power of the LED load unit 13 increases in a case where the display luminance is high, and decreases in a case where the display luminance is low. Furthermore, load power of the system load unit 14 is, for example, several W to several 100 W.

The power supply device 100 outputs a power supply output to be supplied to each load unit. For example, the power supply device 100 outputs a power supply output A as a power supply output to be supplied to the LED load unit 13, and outputs a power supply output B as a power supply output to be supplied to the system load unit 14. The power supply output A is a power supply output having a DC voltage having a first value, for example, a voltage value of 20 V to 40 V. The power supply output B is a power supply output having a DC voltage having a second value, for example, a voltage value of 12.7 V.

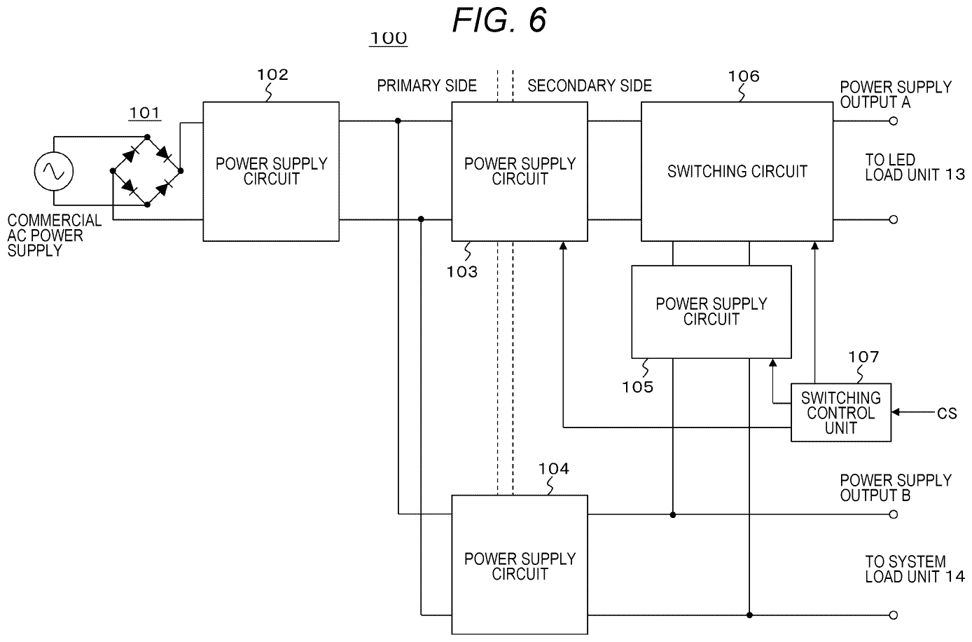

FIG. 6 illustrates a configuration example of the power supply device 100. In this configuration example, a portion related to outputs of the power supply output A and the power supply output B is illustrated, and other portions related to the power supply output are omitted. The power supply device 100 includes a rectifier circuit 101, a power supply circuit 102, a power supply circuit 103, a power supply circuit 104, a power supply circuit 105, a switching circuit 106, and a switching control unit 107.

The rectifier circuit 101 rectifies an input commercial AC power supply. The rectifier circuit 101 is configured as, for example, a bridge rectifier circuit including four rectifier diodes as illustrated in the figure. Note that the configuration of the rectifier circuit 101 is not limited to this bridge rectifier circuit, and may be other configurations.

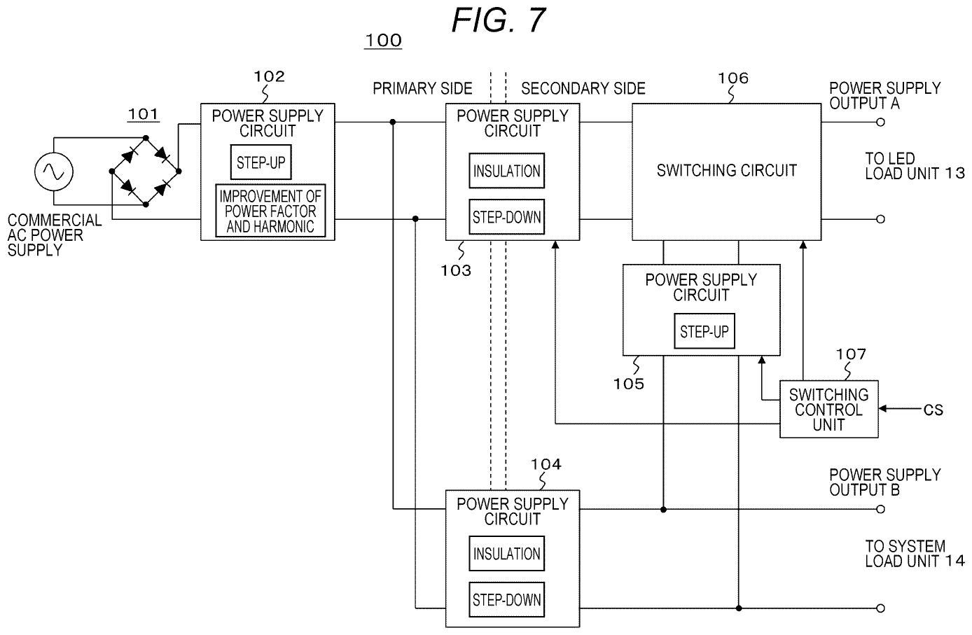

The power supply circuit 102 constitutes a fourth power conversion unit. This power supply circuit 102 constitutes a power conversion unit of a non-insulation type, and outputs a DC input voltage with an output of the rectifier circuit 101 as an input. As illustrated in FIG. 7, the power supply circuit 102 has functions of step-up and improving a power factor and a harmonic, and includes, for example, a power factor correction (PFC) circuit which is a step-up DC-DC converter.

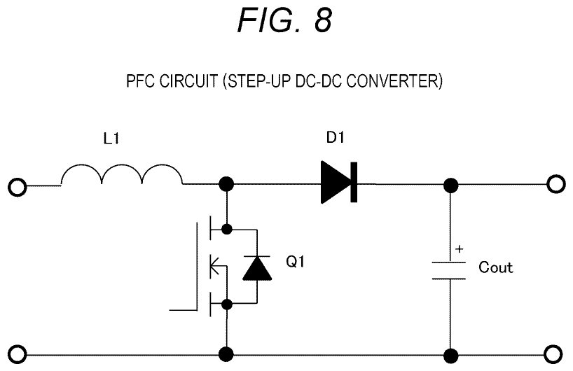

FIG. 8 illustrates a configuration example of a PFC circuit (step-up DC-DC converter). The PFC circuit is conventionally known and thus will not be described in detail, but includes an inductor L1, a switching element Q1, a diode D1, and a smoothing capacitor Cout. The switching element Q1 is configured by a MOSFET, and is switching-driven by a drive control circuit (not illustrated).

Returning to FIG. 6, the power supply circuit 103 constitutes a first power conversion unit. This power supply circuit 103 constitutes a power conversion unit of an insulation type, and obtains a power supply output of a DC voltage having a first value with an output of the power supply circuit 102 as an input. This first value is a voltage value required by the above-described LED load unit 13, for example, 20 V to 40 V. As illustrated in FIG. 7, the power supply circuit 103 has functions of insulation and step-down, and includes, for example, an LLC current resonant DC-DC converter, a flyback converter, or the like.

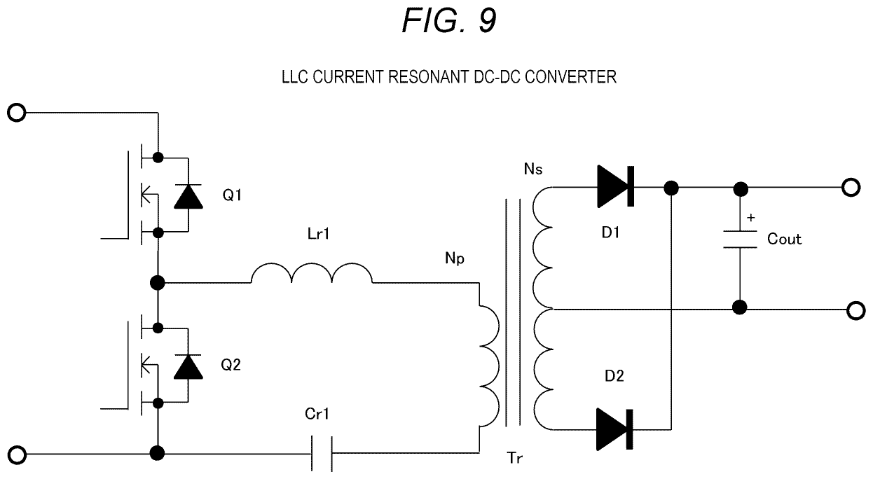

FIG. 9 illustrates a configuration example of an LLC current resonant DC-DC converter. This LLC current resonant DC-DC converter is conventionally known and thus will not be described in detail, but includes switching elements Q1 and Q2, a resonant inductor Lr1, a resonant capacitor Cr1, a transformer Tr, diodes D1 and D2, and a smoothing capacitor Cout. The switching elements Q1 and Q2 are configured by MOSFETS, and are switching-driven by a drive control circuit (not illustrated).

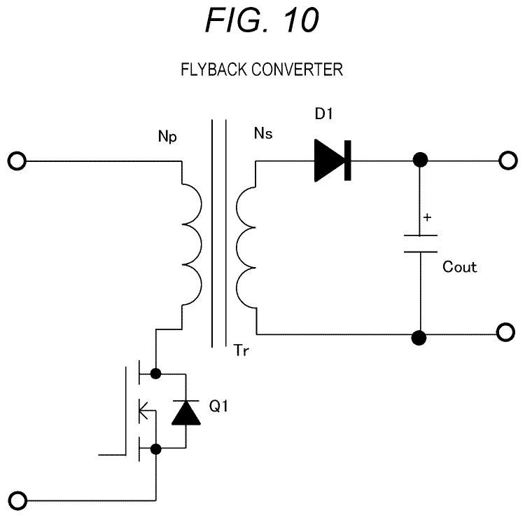

FIG. 10 illustrates a configuration example of a flyback converter. This flyback converter is conventionally known and thus will not be described in detail, but includes a switching element Q1, a transformer Tr, a diode D1, and a smoothing capacitor Cout. The switching element Q1 is configured by a MOSFET, and is switching-driven by a drive control circuit (not illustrated).

Returning to FIG. 6, the power supply circuit 104 constitutes a second power conversion unit. This power supply circuit 104 constitutes a power conversion unit of an insulation type, and obtains a power supply output B of a DC voltage having a second value different from the first value, with an output of the power supply circuit 102 as an input. This second value is a voltage value required by the above-described system load unit 14, and is, for example, 12.7 V. Similarly to the power supply circuit 103 described above, as illustrated in FIG. 7, the power supply circuit 104 has functions of insulation and step-down, and includes, for example, an LLC current resonant converter, a flyback converter, or the like. The power supply output B obtained by the power supply circuit 104 is supplied to the system load unit 14.

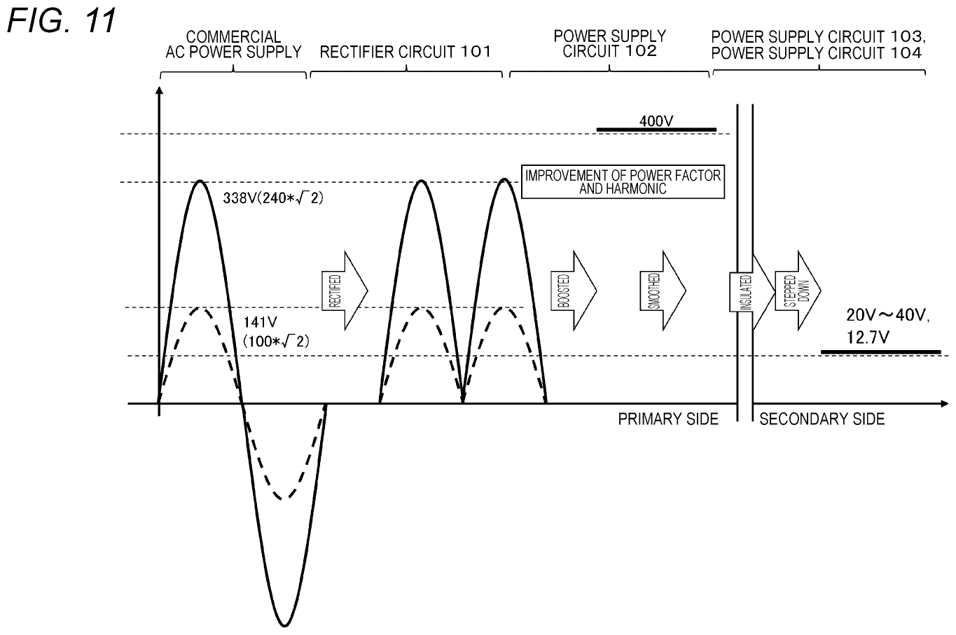

FIG. 11 schematically illustrates operations of the rectifier circuit 101, the power supply circuit 102, and the like in the power supply device 100. Here, a solid line waveform indicates a case where a voltage of the commercial AC power supply is 240 V, and a broken line waveform indicates a case where a voltage of the commercial AC power supply is 100 V. In either case, the voltage is boosted in the power supply circuit 102, and a DC input voltage of, for example, 400 V is output.

Then, in the power supply circuit 103, insulation from the commercial AC power supply and step-down are performed, and a power supply output of a DC voltage having the first value (20 V to 40 V) is obtained. In the power supply circuit 104, insulation from the commercial AC power supply and step-down are performed, and a power supply output (power supply output B) of a DC voltage having the second value (12.7 V) is obtained.

Returning to FIG. 6, the power supply circuit 105 constitutes a third power conversion unit. This power supply circuit 105 constitutes a power conversion unit of a non-insulation type, and obtains a power supply output of the first value with an output of the power supply circuit 104 as input, similarly to the power supply circuit 103 described above. As illustrated in FIG. 7, the power supply circuit 105 has a step-up function, and includes, for example, a step-up DC-DC converter or the like. A power rating of the power supply circuit 105 is made lower than a power rating of the power supply circuit 103.

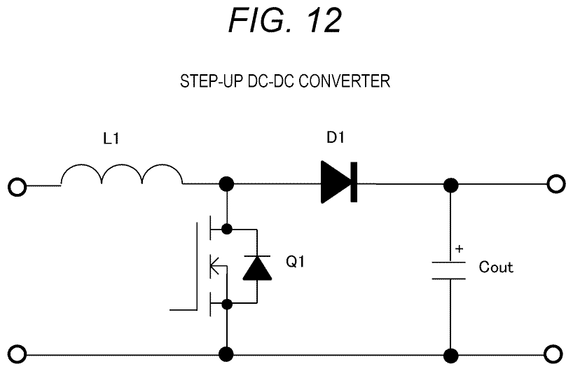

FIG. 12 illustrates a configuration example of a step-up DC-DC converter. This step-up DC-DC converter is conventionally known and thus will not be described in detail, but includes an inductor L1, a switching element Q1, a diode D1, and a smoothing capacitor Cout. The switching element Q1 is configured by a MOSFET, and is switching-driven by a drive control circuit (not illustrated).

Note that, the description has been given above in which a voltage value (first value) required by the LED load unit 13 (see FIG. 5) is, for example, 20 V to 40 V, and a voltage value (second value) required by the system load unit 14 (see FIG. 5), that is, an output voltage value of the power supply circuit 104 is, for example, 12.7 V. Therefore, the power supply circuit 105 has a step-up function.

However, in a case where the first value is smaller than the second value according to a specification of the LED load unit 13, the power supply circuit 105 having a step-down function is used, and is configured by, for example, a step-down DC-DC converter or the like.

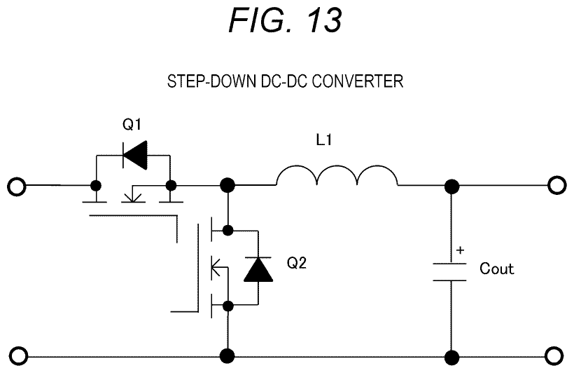

FIG. 13 illustrates a configuration example of a step-down DC-DC converter. This step-down DC-DC converter is conventionally known and thus will not be described in detail,, but includes switching elements Q1 and Q2, an inductor L1, and a smoothing capacitor Cout. The switching elements Q1 and Q2 are configured by MOSFETs, and are switching-driven by a drive control circuit (not illustrated).

Furthermore, according to the specification of the LED load unit 13, in a case where the first value takes both values larger and smaller than the second value, the power supply circuit 105 having a step-up/down function is used, and is configured by, for example, a step-up/down DC-DC converter (SEPIC converter) or the like.

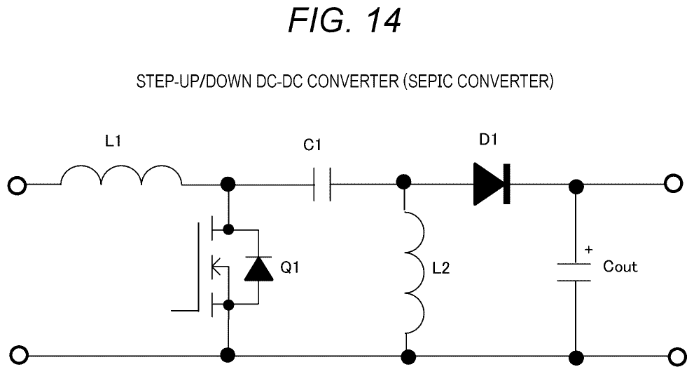

FIG. 14 illustrates a configuration example of a step-up/down DC-DC converter. This step-up/down DC-DC converter is conventionally known and thus will not be described in detail, but includes an inductor L1, a switching element Q1, a capacitor C1, an inductor L2, a diode D1, and a smoothing capacitor Cout.

The switching element Q1 is configured by a MOSFET, and is switching-driven by a drive control circuit (not illustrated).

Returning to FIG. 6, the switching circuit 106 selectively outputs the power supply output of the power supply circuit 103 or the power supply output of the power supply circuit 105, as a power supply output A. The power supply output A output from the switching circuit 106 is supplied to the LED load unit 13.

The switching control unit 107 controls the power supply output A output from the switching circuit 106 on the basis of a control signal CS sent from the CPU 11 (see FIG. 5).

As described above, for example, when the user performs an operation of changing display luminance in image quality setting from the user operation unit 12, the display luminance in the LED load unit 13 is changed under the control of the CPU 11, and load power of the LED load unit 13 changes accordingly. The CPU 11 calculates and obtains load power of the LED load unit 13 on the basis of a voltage value and a current value, or refers to table information indicating a correspondence relationship between the display luminance and the load power. The processing in which the CPU 11 obtains the load power of the LED load unit 13 is performed, for example, when the TV monitor 10 is powered on, and thereafter, is performed every time the display luminance is changed.

The CPU 11 compares the load power of the LED load unit 13 with a threshold, for example, a value of a power rating of the power supply circuit 105, and sets a level of the control signal CS to “1 (High)” or “0 (Low)”. For example, the level of the control signal CS is set to “0 (Low)” in the first mode in which load power of the LED load unit 13 is larger than the threshold and is a heavy load, and set to “1 (High)” in the second mode in which load power of the LED load unit 13 is equal to or less than the threshold and is a light load.

The power supply output A output from the switching circuit 106 is the power supply output obtained by the power supply circuit 103 in the first mode in which the level of the control signal CS is “0 (Low)” and the load power of the LED load unit 13 is larger than the threshold and is a heavy load, and is the power supply output obtained by the power supply circuit 105 in the second mode in which the level of the control signal CS is “1 (High)” and the load power of the LED load unit 13 is equal to or less than the threshold and is a light load.

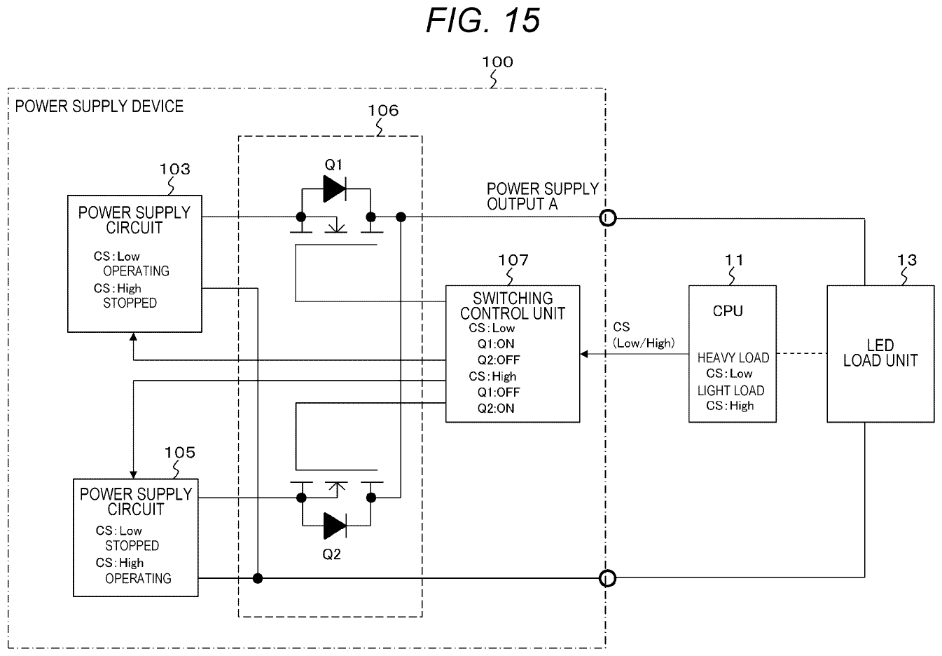

FIG. 15 illustrates an example of a configuration of the switching circuit 106 and an outline of control by the control signal CS. The switching circuit 106 includes switching elements Q1 and Q2 configured by MOSFETs. Note that the switching elements Q1 and Q2 are not limited to those configured by MOSFETs.

The switching element Q1 is disposed on a path between an output side of the switching circuit 106 and the power supply circuit 103, and the switching element Q2 is disposed on a path between the output side of the switching circuit 106 and the power supply circuit 105.

On/off of the switching elements Q1 and Q2 is controlled by the switching control unit 107 on the basis of the control signal CS. In this case, when the control signal CS is “0 (Low)”, the switching element Q1 is turned on, and the switching element Q2 is turned off. Furthermore, when the control signal CS is “1 (High)”, the switching element Q1 is turned off, and the switching element Q2 is turned on.

Furthermore, operations of the power supply circuit 103 and the power supply circuit 105 are controlled by the switching control unit 107 on the basis of the control signal CS. In this case, when the control signal CS is “0 (Low)”, the power supply circuit 103 is set to an operating state, and the power supply circuit 105 is set to a stopped state. Furthermore, when the control signal CS is “1 (High)”, the power supply circuit 103 is set to a stopped state, and the power supply circuit 105 is set to an operating state. Note that, although not illustrated in FIG. 15, the power supply circuit 102 and the power supply circuit 104 are always in an operating state.

As a result, when the load power of the LED load unit 13 is larger than the threshold and is a heavy load, the power supply output obtained by the power supply circuit 103 is output from the switching circuit 106 as the power supply output A. Whereas, when the load power of the LED load unit 13 is equal to or less than the threshold and is a light load, the power supply output obtained by the power supply circuit 105 is output from the switching circuit 106 as the power supply output A.

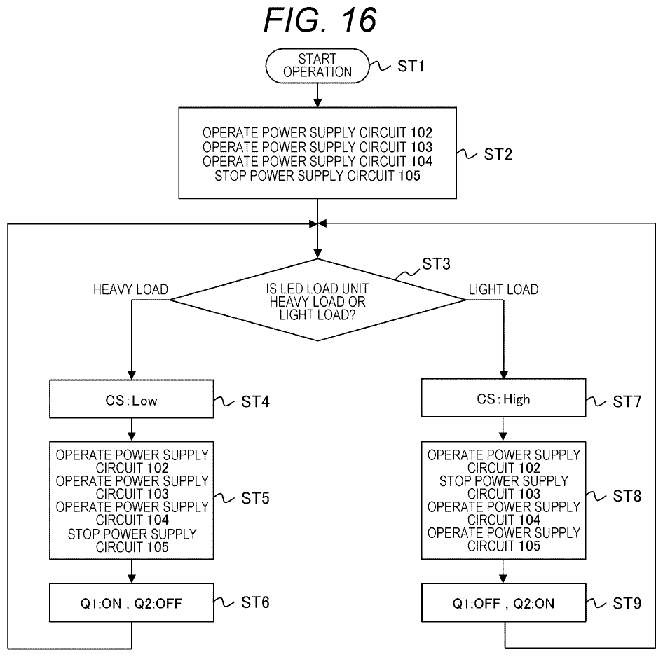

A flowchart of FIG. 16 illustrates an example of operation control performed by the CPU 11 on a portion related to the power supply output A of the power supply device 100 in the configuration example of FIG. 15.

First, the CPU 11 starts an operation in step ST1. Next, in step ST2, the CPU 11 sets the power supply circuit 102 to the operating state, the power supply circuit 103 to the operating state, the power supply circuit 104 to the operating state, and the power supply circuit 105 to the stopped state.

Next, in step ST3, the CPU 11 determines whether the LED load unit 13 is a heavy load or a light load. In this case, the CPU 11 obtains load power of the LED load unit 13, compares the load power with the threshold, and determines whether the LED load unit 13 is a heavy load or a light load.

When determining that the LED load unit 13 is a heavy load, the CPU 11 sets the control signal CS to be sent to the power supply device 100 to “0 (Low)” in step ST4. Next, in step ST5, the CPU 11 sets the power supply circuit 102 to the operating state, the power supply circuit 103 to the operating state, the power supply circuit 104 to the operating state, and the power supply circuit 105 to the stopped state.

Next, in step ST6, the CPU 11 turns on the switching element Q1 and turns off the switching element Q2 in the switching circuit 106, and sets a state in which the power supply output obtained by the power supply circuit 103 is output as the power supply output A. After the processing of step ST6, the CPU 11 returns to the processing of step ST3.

Furthermore, when determining in step ST3 that the LED load unit 13 is a light load, the CPU 11 sets the control signal CS to be sent to the power supply device 100 to “1 (High)” in step ST7. Next, in step ST8, the CPU 11 sets the power supply circuit 102 to the operating state, the power supply circuit 103 to the stopped state, the power supply circuit 104 to the operating state, and the power supply circuit 105 to the operating state.

Next, in step ST9, the CPU 11 turns off the switching element Q1 and turns on the switching element Q2 in the switching circuit 106, and sets a state in which the power supply output obtained by the power supply circuit 105 is output as the power supply output A. After the processing of step ST9, the CPU 11 returns to the processing of step ST3.

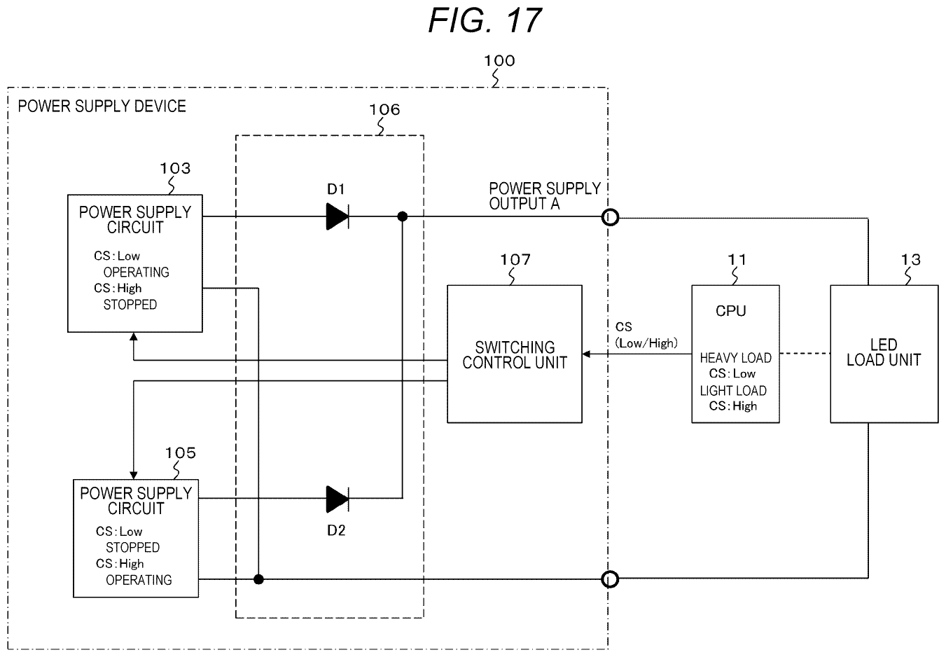

FIG. 17 illustrates an example of another configuration of the switching circuit 106 and an outline of control by the control signal CS. The switching circuit 106 includes diodes D1 and D2. The diode D1 is disposed on a path between the output side of the switching circuit 106 and the power supply circuit 103, and the diode D1 is disposed on a path between the output side of the switching circuit 106 and the power supply circuit 105.

Operations of the power supply circuit 103 and the power supply circuit 105 are controlled by the switching control unit 107 on the basis of the control signal CS. In this case, when the control signal CS is “0 (Low)”, the power supply circuit 103 is set to an operating state, and the power supply circuit 105 is set to a stopped state. Furthermore, when the control signal CS is “1 (High)”, the power supply circuit 103 is set to a stopped state, and the power supply circuit 105 is set to an operating state. Note that, although not illustrated in FIG. 17, the power supply circuit 102 and the power supply circuit 104 are always in an operating state.

As a result, similarly to the configuration example of FIG. 15, when the load power of the LED load unit 13 is larger than the threshold and is a heavy load, the power supply output obtained by the power supply circuit 103 is output from the switching circuit 106 as the power supply output A. Whereas, when the load power of the LED load unit 13 is equal to or less than the threshold and is a light load, the power supply output obtained by the power supply circuit 105 is output from the switching circuit 106 as the power supply output A.

Note that, in the case of the configuration example of FIG. 17, there is a forward voltage drop in the diodes D1 and D2, and a conduction loss occurs. Whereas, in the case of the configuration example of FIG. 15, such a conduction loss can be suppressed.

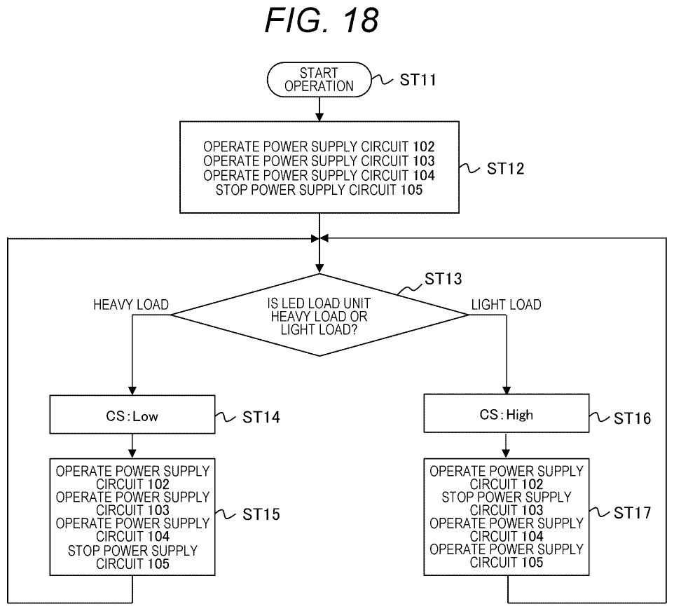

A flowchart of FIG. 18 illustrates an example of operation control performed by the CPU 11 on a portion related to the power supply output A of the power supply device 100 in the configuration example of FIG. 17.

First, the CPU 11 starts an operation in step ST11. Next, in step ST12, the CPU 11 sets the power supply circuit 102 to the operating state, the power supply circuit 103 to the operating state, the power supply circuit 104 to the operating state, and the power supply circuit 105 to the stopped state.

Next, in step ST13, the CPU 11 determines whether the LED load unit 13 is a heavy load or a light load. In this case, the CPU 11 obtains load power of the LED load unit 13, compares the load power with the threshold, and determines whether the LED load unit 13 is a heavy load or a light load.

When determining that the LED load unit 13 is a heavy load, the CPU 11 sets the control signal CS to be sent to the power supply device 100 to “0 (Low)” in step ST14. Next, in step ST15, the CPU 11 sets the power supply circuit 102 to the operating state, the power supply circuit 103 to the operating state, the power supply circuit 104 to the operating state, and the power supply circuit 105 to the stopped state, and sets a state in which the power supply output obtained by the power supply circuit 103 is output as the power supply output A. After the processing of step ST5, the CPU 11 returns to the processing of step ST13.

Furthermore, when determining in step ST13 that the LED load unit 13 is a light load, the CPU 11 sets the control signal CS to be sent to the power supply device 100 to “1 (High)” in step ST16. Next, in step ST17, the CPU 11 sets the power supply circuit 102 to the operating state, the power supply circuit 103 to the stopped state, the power supply circuit 104 to the operating state, and the power supply circuit 105 to the operating state, and sets a state in which the power supply output obtained by the power supply circuit 105 is output as the power supply output A. After the processing of step ST17, the CPU 11 returns to the processing of step ST3.

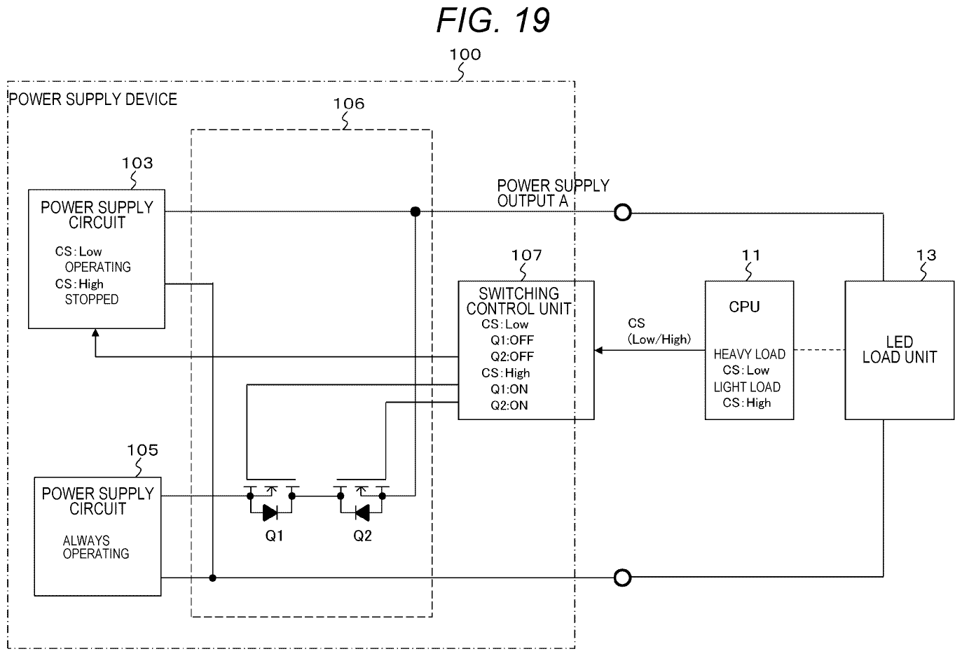

FIG. 19 illustrates an example of still another configuration of the switching circuit 106 and an outline of control by the control signal CS. This example is an example in which the power supply circuit 105 is always set into an operating state. In the switching circuit 106, two MOSFETs are disposed in series on a path between the output side of the switching circuit 106 and the power supply circuit 105 such that directions of parasitic diodes are opposite to each other. In this case, the two MOSFETs constitute switching elements Q1 and Q2.

On/off of the switching elements Q1 and Q2 is controlled by the switching control unit 107 on the basis of the control signal CS. In this case, when the control signal CS is “0 (Low)”, the switching elements Q1 and Q2 are turned off. Furthermore, when the control signal CS is “1 (High)”, the switching elements Q1 and Q2 are turned on.

Furthermore, the operation of the power supply circuit 103 is controlled by the switching control unit 107 on the basis of the control signal CS. In this case, when the control signal CS is “0 (Low)”, the power supply circuit 103 is set to an operating state. Furthermore, when the control signal CS is “1 (High)”, the power supply circuit 103 is in a stopped state.

Note that, as described above, the power supply circuit 105 is always in an operating state, and the power supply circuit 102 and the power supply circuit 104 are always in an operating state, although not illustrated in FIG. 19.

As a result, when the load power of the LED load unit 13 is larger than the threshold and is a heavy load, the power supply output obtained by the power supply circuit 103 is output from the switching circuit 106 as the power supply output A. In this case, the power supply circuit 105 is in the operating state.

However, the two switching elements Q1 and Q2 connected in series are turned off and connected in series such that the directions of the parasitic diodes thereof are opposite to each other, so that the path from the power supply circuit 105 to the output side of the switching circuit 106 is completely cut off, and thus the power supply output obtained by the power supply circuit 105 is not output as the power supply output A. Whereas, when the load power of the LED load unit 13 is equal to or less than the threshold and is a light load, the power supply output obtained by the power supply circuit 105 is output from the switching circuit 106 as the power supply output A.

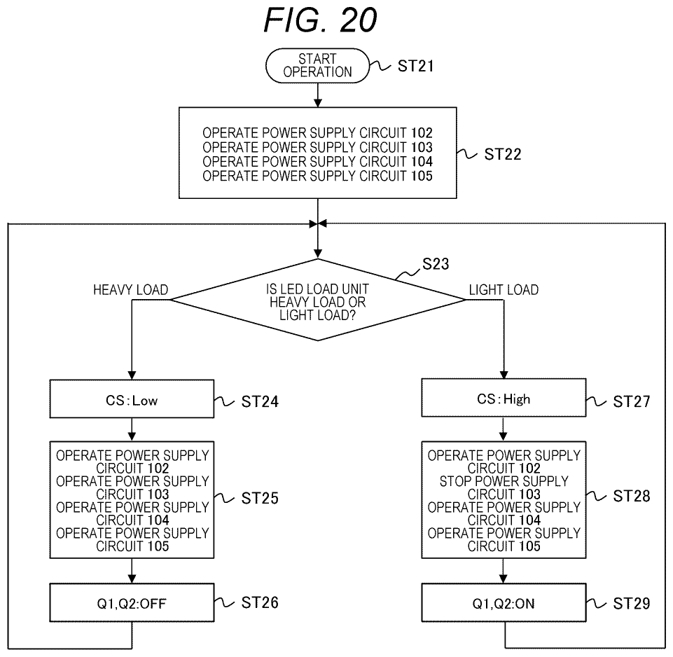

A flowchart of FIG. 20 illustrates an example of operation control performed by the CPU 11 on a portion related to the power supply output A of the power supply device 100 in the configuration example of FIG. 19.

First, the CPU 11 starts an operation in step ST21. Next, in step ST22, the CPU 11 sets the power supply circuit 102 to the operating state, the power supply circuit 103 to the operating state, the power supply circuit 104 to the operating state, and the power supply circuit 105 to the operating state.

Next, in step ST23, the CPU 11 determines whether the LED load unit 13 is a heavy load or a light load. In this case, the CPU 11 obtains load power of the LED load unit 13, compares the load power with the threshold, and determines whether the LED load unit 13 is a heavy load or a light load.

When determining that the LED load unit 13 is a heavy load, the CPU 11 sets the control signal CS to be sent to the power supply device 100 to “0 (Low)” in step ST24. Next, in step ST25, the CPU 11 sets the power supply circuit 102 to the operating state, the power supply circuit 103 to the operating state, the power supply circuit 104 to the operating state, and the power supply circuit 105 to the operating state.

Next, in step ST26, the CPU 11 turns off both the switching elements Q1 and Q2 of the switching circuit 106, and sets a state in which the power supply output obtained by the power supply circuit 103 is output as the power supply output A. After the processing of step ST26, the CPU 11 returns to the processing of step ST23.

Furthermore, when determining in step ST23 that the LED load unit 13 is a light load, the CPU 11 sets the control signal CS to be sent to the power supply device 100 to “1 (High)” in step ST27. Next, in step ST28, the CPU 11 sets the power supply circuit 102 to the operating state, the power supply circuit 103 to the stopped state, the power supply circuit 104 to the operating state, and the power supply circuit 105 to the operating state.

Next, in step ST29, the CPU 11 turns on both the switching elements Q1 and Q2 of the switching circuit 106, and sets a state in which the power supply output obtained by the power supply circuit 105 is output as the power supply output A. After the processing of step ST29, the CPU 11 returns to the processing of step ST23.

Note that, although detailed description is omitted, a configuration in which an AC relay, a photo MOSFET, or the like is disposed is also conceivable as the configuration of the switching circuit 106, in addition to the examples illustrated in FIGS. 15, 17, and 19 described above.

As described above, in the TV monitor 10 illustrated in FIG. 5, in the second mode in which load power of the LED load unit 13 is equal to or less than the threshold and is a light load, the power supply device 100 (see FIG. 6) outputs, from the switching circuit 106, not the power supply output obtained by the power supply circuit 103 with a large power rating but the power supply output obtained by the power supply circuit 105 with a small power rating via the power supply circuit 104 as the power supply output A, and supplies the power supply output A to the LED load unit 13. Therefore, it becomes possible to suppress a power loss when the load power decreases, and improve the efficiency.

Note that, in the power supply device 100 illustrated in FIG. 6, in the second mode in which load power of the LED load unit 13 is equal to or less than the threshold and is a light load, the power supply output obtained by the power supply circuit 105 is output as the power supply output A from an output switching circuit 106. Further, the power supply circuit 102, the power supply circuit 104, and the power supply circuit 105 are set into the operating state, and the power supply circuit 103 is set into the stopped state.

However, at this time, it is conceivable to set the power supply circuit 104 and the power supply circuit 105 to the operating state, and the power supply circuit 102 and the power supply circuit 103 to the stopped state, to further reduce loss power and enhance the power supply efficiency.

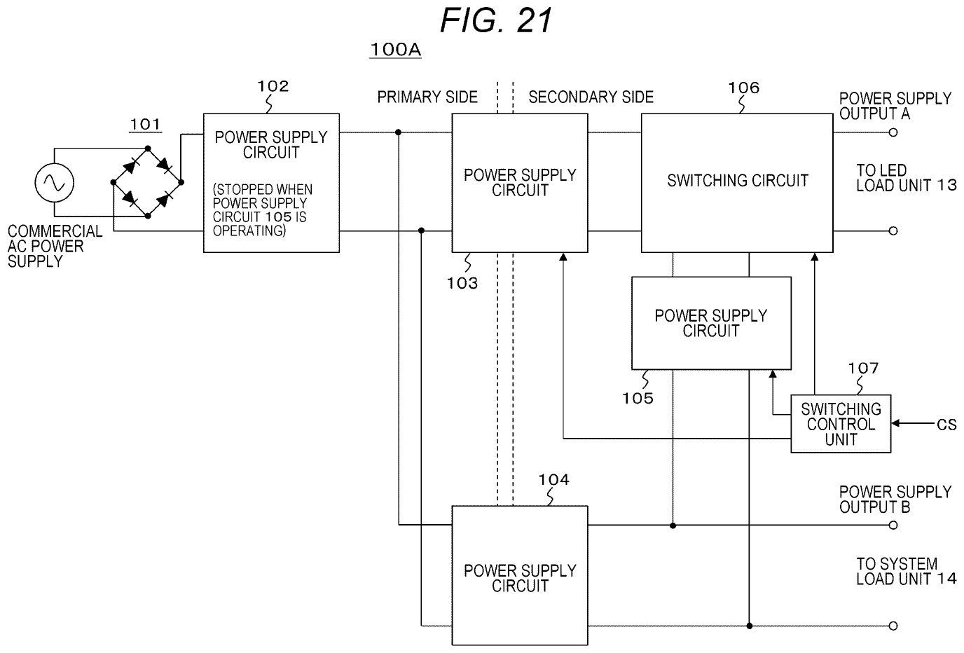

FIG. 21 illustrates a configuration example of a power supply device 100A in that case. In this FIG. 21, portions corresponding to those in FIG. 6 are given with the same reference numerals, and detailed description thereof will be omitted as appropriate.

In the power supply device 100A, in a case where a power supply output obtained by the power supply circuit 105 is output as the power supply output A from the output switching circuit 106, the power supply circuit 102 is set to a stopped state together with the power supply circuit 103.

In this case, since the power supply circuit 102 is in the stopped state, a power factor and a harmonic are not improved. However, in the second mode in which load power of the LED load unit 13 is equal to or less than the threshold and is a light load, a countermeasure against harmonics becomes unnecessary, and thus there is no problem. The threshold at this time is determined, for example, such that input power of the power supply device 100A is 75 W or less.

Furthermore, in this case, since the power supply circuit 102 is in the stopped state, boosting is not performed. Therefore, an output voltage of the power supply circuit 102 is obtained by smoothing a rectified portion of the commercial AC power supply by the smoothing capacitor disposed at an output stage. For example, the output voltage of the power supply circuit 102 is approximately 141 V in a case where a voltage of the commercial AC power supply is 100 V, and the output voltage of the power supply circuit 102 is approximately 338 V in a case where a voltage of the commercial AC power supply is 240 V.

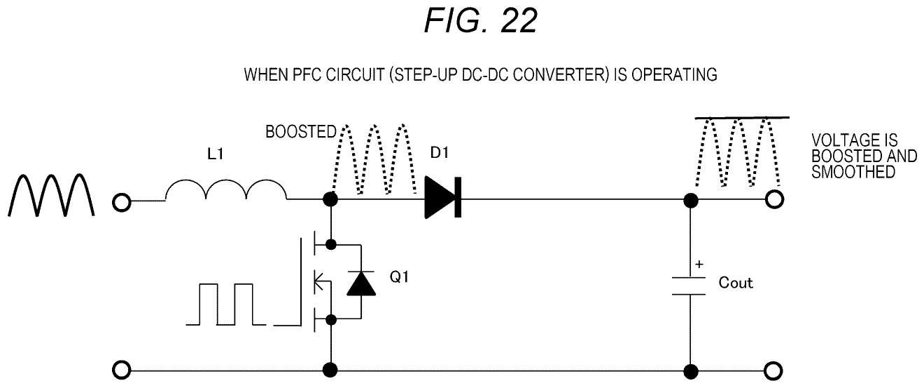

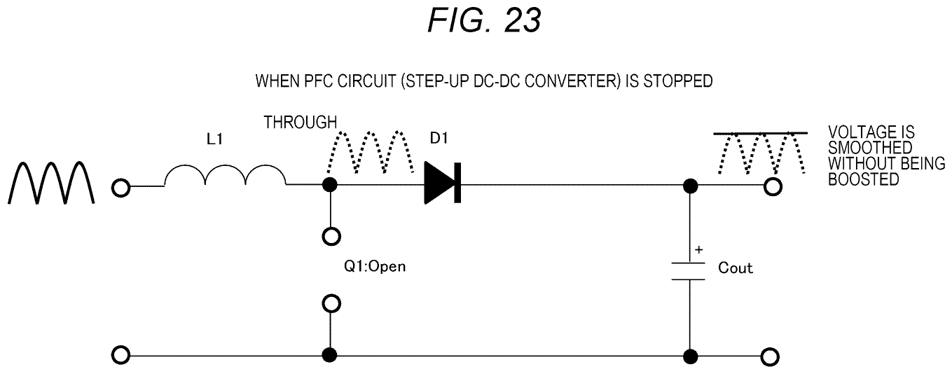

FIG. 22 schematically illustrates an operation when the PFC circuit (step-up DC-DC converter) constituting the power supply circuit 102 is in operation. In this case, an output voltage of the rectifier circuit 301 is input, boosted by the on/off operation of the switching element Q1, and then smoothed by the smoothing capacitor Cout to become a DC input voltage. FIG. 23 schematically illustrates an operation when the PFC circuit (step-up DC-DC converter) constituting the power supply circuit 102 is stopped. In this case, an output voltage of the rectifier circuit 101 is input, and smoothed by the smoothing capacitor Cout to become a DC input voltage.

As described above, when the power supply circuit 102 is in the stopped state, the output voltage of the power supply circuit 102 fluctuates according to the voltage of the commercial AC power supply, and takes a wide voltage range.

However, in this case, by configuring the power supply circuit 104 with a power supply circuit having high line regulation performance, for example, a flyback converter, voltage values of the power supply output A and the power supply output B can be maintained at values similar to those in the case of the power supply device 100 of FIG. 6.

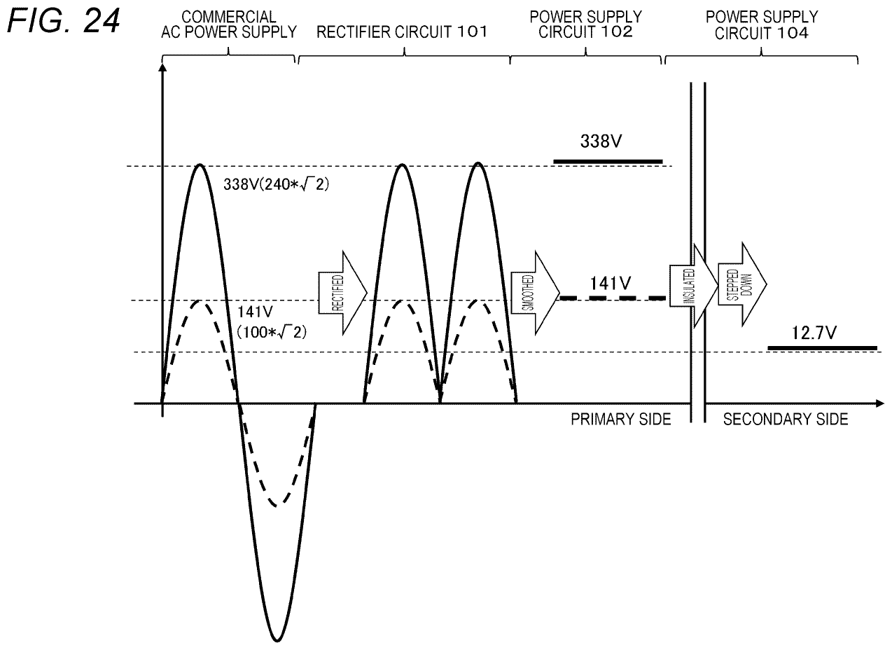

FIG. 24 schematically illustrates operations of the rectifier circuit 101, the power supply circuit 102, and the like in the second mode in which load power of the LED load unit 13 is equal to or less than the threshold and is a light load in the power supply circuit 100A. Here, a solid line waveform indicates a case where a voltage of the commercial AC power supply is 240 V, and a broken line waveform indicates a case where a voltage of the commercial AC power supply is 100 V. In either case, the power supply circuit 102 does not perform boosting, and outputs DC input voltages of approximately 141 V and 338 V, respectively. Then, in the power supply circuit 104, insulation from the commercial AC power supply and step-down are performed, and a power supply output (power supply output B) of a DC voltage having a second value (12.7 V) is obtained.

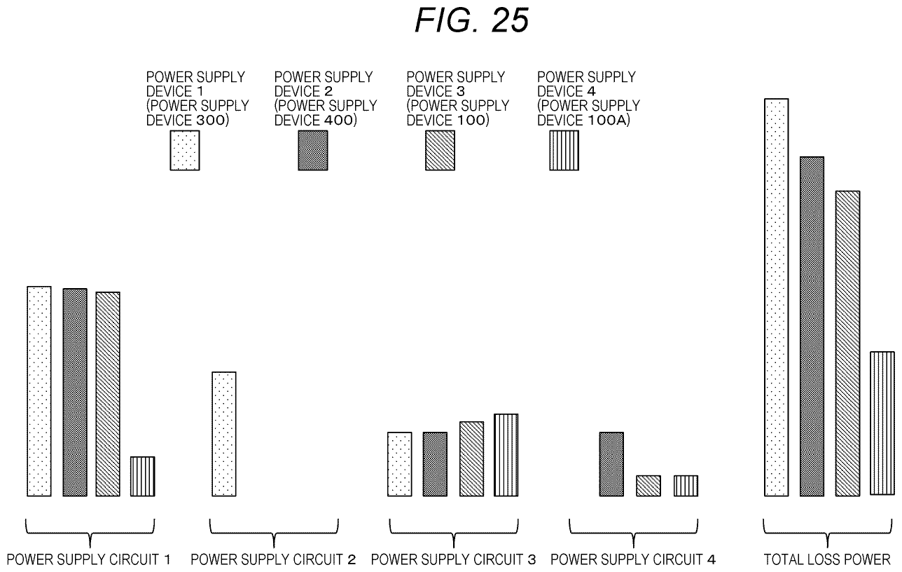

FIG. 25 schematically illustrates, with bar charts, individual power circuits and entire loss power of the power supply device 300 (here, defined as “power supply device 1”) illustrated in FIG. 1, the power supply device 400 (here, defined as “power supply device 2”) illustrated in FIG. 3, the power supply device 100 (here, defined as “power supply device 3”) illustrated in FIG. 6, and the power supply device 100A (here, defined as “power supply device 4”) illustrated in FIG. 21, when the first load unit is a light load. Note that, in the power supply device 100 and 100A, the LED load unit 13 corresponds to the first load unit.

Furthermore, in the power supply device 300, the power supply circuit 302 constitutes a power supply circuit 1, the power supply circuit 303 constitutes a power supply circuit 2, and the power supply circuit 304 constitutes a power supply circuit 3. Furthermore, in the power supply device 400, the power supply circuit 402 constitutes a power supply circuit 1, the power supply circuit 403 constitutes a power supply circuit 2, the power supply circuit 404 constitute a power supply circuit 3, and the power supply circuit 405 constitutes a power supply circuit 4.

Furthermore, in the power supply device 100 and 100A, the power supply circuit 102 constitutes a power supply circuit 1, the power supply circuit 103 constitutes a power supply circuit 2, the power supply circuit 104 constitute a power supply circuit 3, and the power supply circuit 105 constitutes a power supply circuit 4.

Regarding the power supply circuit 1, since the power supply device 4 is in the stopped state, a loss is the smallest. Regarding the power supply circuit 2, only the power supply device 1 is set to the operating state, and a loss occurs. Regarding the power supply circuit 3, since the power supply device 3 is configured to further use an output of the power supply circuit 3 in the power supply circuit 4, a loss is slightly larger than those of the power supply devices 1 and 2. Furthermore, regarding the power supply circuit 3, since the power supply device 4 uses a flyback converter having good line regulation characteristics, a loss is slightly larger than that in a case of the power supply device 3 using, for example, an LLC current resonant converter. Regarding the power supply circuit 4, there is no loss in the power supply device 1 since the power supply circuit 4 is not used, and losses in the power supply devices 2 and 3 are smaller than that of the power supply device 2 of an insulation type since the power supply devices 2 and 3 are non-insulation types.

Therefore, as the entire power supply device, the loss power of the power supply device 3 is smaller than the loss power of the power supply devices 1 and 2, and the loss power of the power supply device 4 is further smaller than the loss power of the power supply device 3.

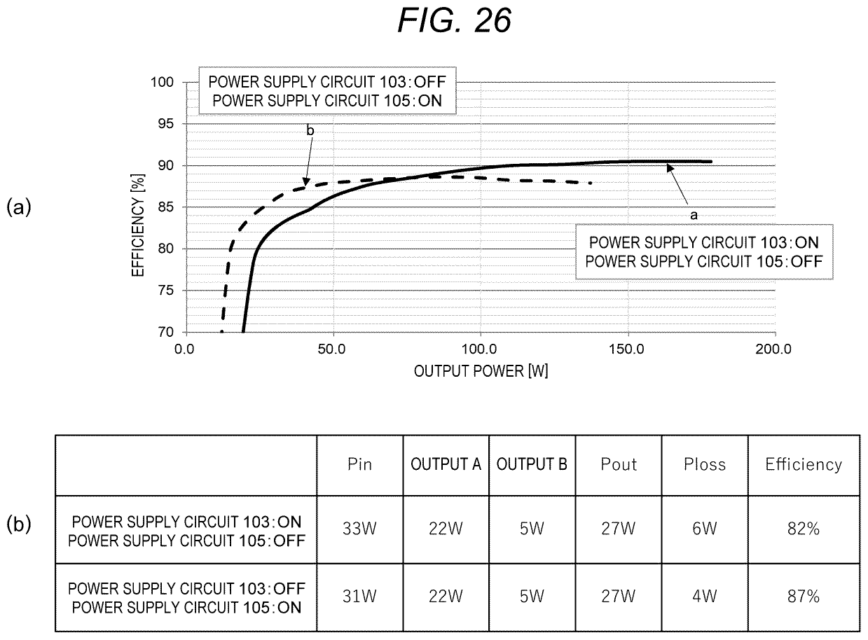

In the graph of FIG. 26(a), a solid line “a” indicates a correspondence relationship between output power [W] and efficiency [%] in a first case (corresponding to the power supply device 100 illustrated in FIG. 1) in which the power supply circuit 103 is in the operating state (ON) and the power supply circuit 105 is in the stopped state (OFF) in the power supply device 300 illustrated in FIG. 6. Furthermore, in the graph of FIG. 26(a), a broken line “b” indicates a correspondence relationship between output power [W] and efficiency [%] in a second case where the power supply circuit 103 is in the stopped state (OFF) and the power supply circuit 105 is in the operating state (ON) in the power supply device 100 illustrated in FIG. 6.

FIG. 26(b) illustrates an example of input power Pin, output power Pout, loss power Ploss, and efficiency Efficiency at the time of a light load in the first case and the second case described above. In the first case, when an output A (power supply output A) was 22 W, an output B (power supply output B) was 5 W, and Pout was 27 W, Pin was 33 W, Ploss was 6 W, and Efficiency was 82%. Whereas, in the second case described above, when the output A (power supply output A) was 22 W, the output B (power supply output B) was 5 W, and Pout was 27 W, Pin was 31 W, Ploss was 4 W, and Efficiency was 87%.

From this result, it can be seen that, in the power supply device 100 illustrated in FIG. 6, the loss power at the time of a light load is reduced and efficiency is improved as compared with the power supply device 300 illustrated in FIG. 1.

### <2. Modifications>

Note that the power supply device 100 illustrated in FIG. 6 described above has a configuration in which the commercial AC power supply is rectified by the rectifier circuit 101 and then input to the power supply circuit 102 to generate the input DC voltage. However, it is also conceivable to use a power supply circuit capable of directly generating the input DC voltage from the commercial AC power supply without using the rectifier circuit that converts the AC voltage into the DC pulsating voltage.

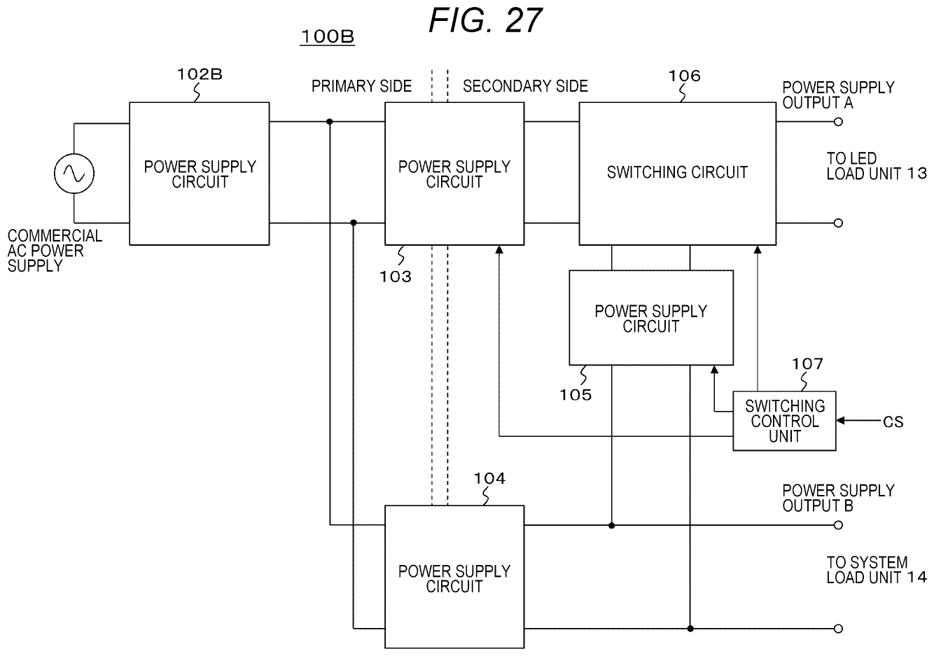

FIG. 27 illustrates a configuration example of a power supply device 100B in that case. In this FIG. 27, portions corresponding to those in FIG. 6 are given with the same reference numerals, and detailed description thereof will be omitted as appropriate. In the power supply device 100B, the commercial AC power supply is directly input to a power supply circuit 102B, and an input DC voltage is generated similarly to the power supply circuit 102 in the power supply device 100 illustrated in FIG. 6. The rest of the power supply device 100B is configured similarly to the power supply device 100 illustrated in FIG. 6. The power supply circuit 102B includes, for example, a totem-pole PFC circuit, a dual boost PFC circuit, or the like.

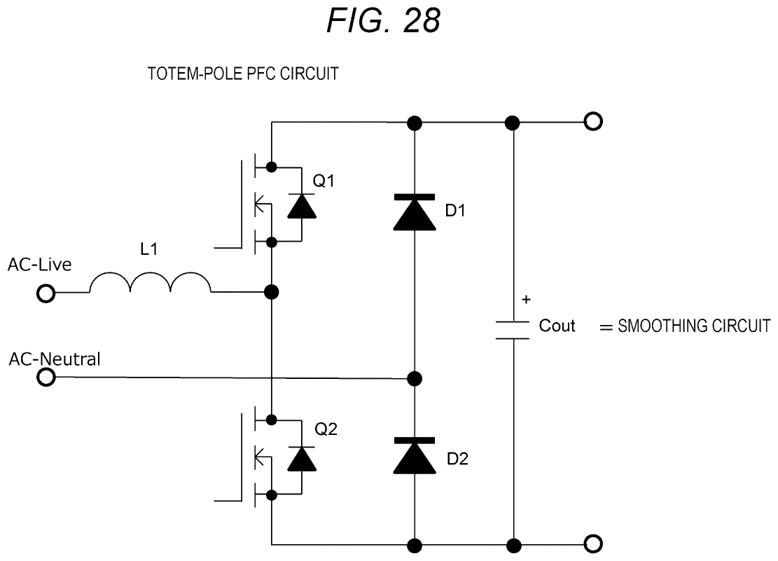

FIG. 28 illustrates a configuration example of a totem-pole PFC circuit. The totem-pole PFC circuit is conventionally known and thus will not be described in detail, but includes an inductor L1, switching elements Q1 and Q2, diodes D1 and D2, and a smoothing capacitor Cout. The switching elements Q1 and Q2 are configured by MOSFETs, and are switching-driven by a drive control circuit (not illustrated).

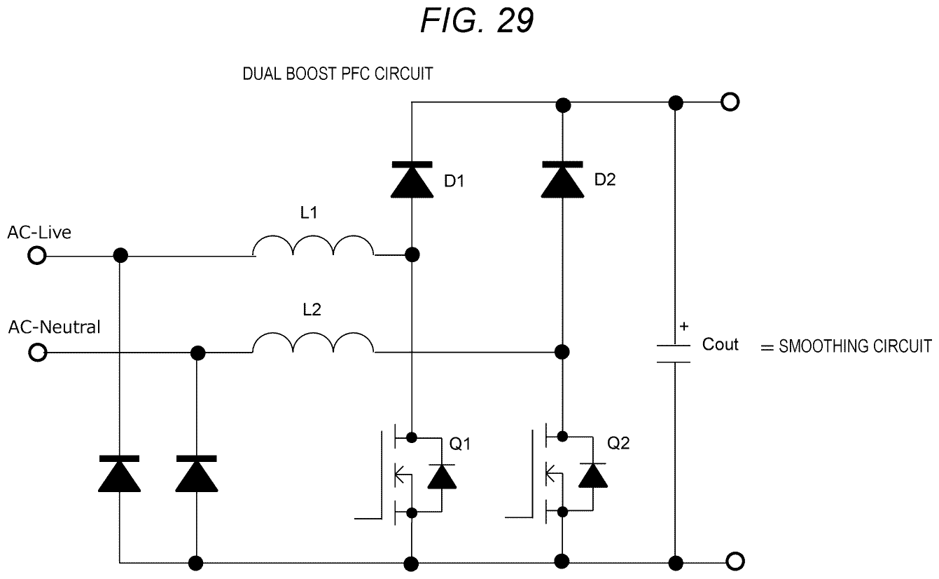

FIG. 29 illustrates a configuration example of a dual boost PFC circuit. The dual boost PFC circuit is conventionally known and thus will not be described in detail, but includes inductors L1 and L2, switching elements Q1 and Q2, diodes D1 and D2, and a smoothing capacitor Cout. The switching elements Q1 and Q2 are configured by MOSFETs, and are switching-driven by a drive control circuit (not illustrated).

Furthermore, in the above-described embodiment, the TV monitor 10 as an example of an electrical equipment device including the power supply device of the present technology has been described (see FIG. 5). However, the electrical equipment device including the power supply device of the present technology is not limited to the TV monitor 10.

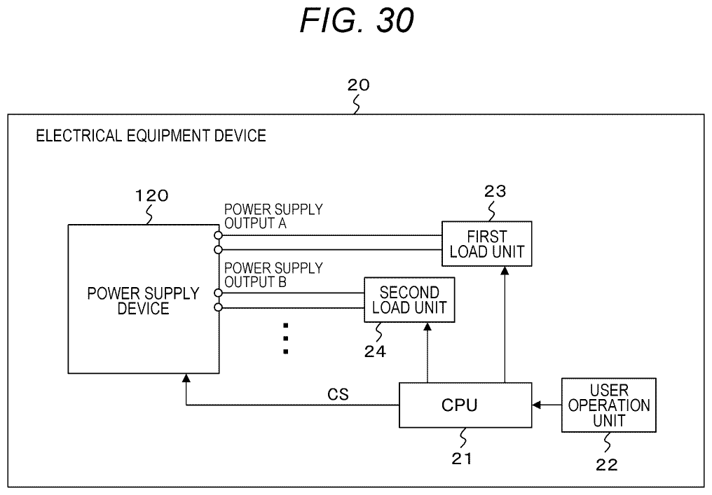

FIG. 30 illustrates a configuration example of a general electrical equipment device 20 including the power supply device of the present technology. The electrical equipment device 20 includes a central processing unit (CPU) 21, a user operation unit 22, a first load unit 23, a second load unit 24, and a power supply device 120.

The CPU 21 constitutes a control unit that controls the entire electrical equipment device 20. The user operation unit 22 receives various operations of a user, and transmits an operation signal to the CPU 21. The first load unit 23 is a load unit corresponding to the LED load unit 13 in the TV monitor 10 illustrated in FIG. 5 described above. The second load unit 24 is a load unit corresponding to the system load unit 14 in the TV monitor 10 illustrated in FIG. 5 described above. Note that, in the illustrated example, only two of the first load unit 23 and the second load unit 24 are illustrated, and illustration of other load units is omitted for simplification of description.

Similarly to the LED load unit 13 in the TV monitor 10 illustrated in FIG. 5, load power of the first load unit 23 changes to a heavy load or a light load depending on, for example, an operation state of the first load unit 23 set by a user through the user operation unit 22.

The power supply device 120 is configured similarly to the power supply device 100 (see FIG. 6) in the TV monitor 10 illustrated in FIG. 5. Note that the power supply device 120 may be configured similarly to the power supply device 100A (see FIG. 21) and the power supply device 100B (see FIG. 27). A control signal CS is supplied from the CPU 21 to the power supply device 120. A level of the control signal CS is “0 (Low)” in a first mode in which load power of the first load unit 23 is larger than a threshold and is a heavy load, and is “1 (High)” in a second mode in which load power of the first load unit 23 is equal to or less than the threshold and is a light load.

The power supply device 120 outputs a power supply output to be supplied to each load unit. For example, the power supply device 120 is controlled by the control signal CS as power to be supplied to the first load unit 23, and outputs a power supply output A similarly to that of the power supply device 100 illustrated in FIG. 6 and outputs a power supply output B similarly to that of the power supply device 100 illustrated in FIG. 6, as the power to be supplied to the second load unit 24.

Since the power supply output A output from the power supply device 120 is controlled by the control signal CS in this manner, similarly to the power supply device 100 illustrated in FIG. 6, the power supply device 120 can suppress a power loss when the load power decreases, to improve the efficiency.

Furthermore, in the above-described embodiment, it has been described that the power supply circuits 103 and 104 as the first and second power conversion units includes, for example, the LLC current resonant converter (see FIG. 9) and the flyback converter (see FIG. 10), but the first and second power conversion units according to the present technology include general insulation converters having other similar functions. Furthermore, in the above-described embodiment, it has been described that the power supply circuit 105 as the third power conversion unit includes, for example, a step-up DC-DC converter (see FIG. 12), a step-down DC-DC converter (see FIG. 13), a step-up/down DC-DC converter (SEPIC converter) (see FIG. 14), or the like, but the third power conversion unit according to the present technology includes a general non-insulation converter having other similar functions. Furthermore, in the above-described embodiment, an example has been described in which a switching element, a diode, an AC relay, a photo MOSFET, or the like is disposed as the switching circuit 106 as the switching unit (see FIGS. 15, 17, and 19), but the switching circuit in the present technology includes a general switching circuit having other similar functions.

Furthermore, although the preferred embodiment of the present disclosure has been described above in detail with reference to the accompanying drawings, the technical scope of the present disclosure is not limited to such an example. It is apparent that a person having ordinary knowledge in the technical field of the present disclosure can achieve various type of examples of changes or modifications within the scope of the technical idea recited in the claims, and it will be naturally understood that such examples also belong to the technical scope of the present disclosure.

Furthermore, the effects described in the present specification are merely exemplary or illustrative, and not restrictive. That is, the technology according to the present disclosure may produce other effects that are apparent to those skilled in the art from the description of the present specification, in combination with or instead of the effects described above.

Meanwhile, the present technology may also have a following configuration.
(1) An electrical equipment device including:
   a first load unit;
   a second load unit; and
   a power supply device, in which
   the power supply device includes:
   an input voltage generation unit configured be input with a commercial alternating current (AC) power supply to generate a direct current (DC) input voltage;
   a first power conversion unit being of an insulation type and configured to be input with the DC input voltage to obtain a first power supply output of a DC voltage having a first value;
   a second power conversion unit being of an insulation type and configured to be input with the DC input voltage to obtain a second power supply output of a DC voltage having a second value different from the first value;
   a third power conversion unit being of a non-insulation type and configured to be input with the DC voltage having the second value to obtain a third power supply output of a DC voltage having the first value;
   a switching unit configured to selectively output the first power supply output or the third power supply output;
   a power supply output supply unit configured to supply a power supply output that is output from the switching unit to the first load unit, and supply the second power supply output to the second load unit; and
   a control unit configured to cause the switching unit to output the first power supply output in a first mode in which load power of the first load unit is larger than a threshold, and cause the switching unit to output the third power supply output in a second mode in which load power of the first load unit is equal to or less than the threshold.
(2) The electrical equipment device according to (1) above, in which
   the control unit stops the third power conversion unit in the first mode, and stops the first power conversion unit in the second mode.
(3) The electrical equipment device according to (2) above, in which
   the switching unit has a configuration in which a switching element or a diode is disposed on each of a path between an output side and the first power conversion unit and a path between the output side and the third power conversion unit.
(4) The electrical equipment device according to (1) above, in which
   the control unit stops the first power conversion unit in the second mode.
(5) The electrical equipment device according to (4) above, in which
   the switching unit has a configuration in which two metal-oxide-semiconductor field-effect transistors (MOSFETs) are disposed in series on a path between an output side and the third power conversion unit such that directions of parasitic diodes are opposite to each other.
(6) The electrical equipment device according to any one of (1) to (5) above, in which
   the input voltage generation unit includes a rectification unit that rectifies the commercial AC power supply, and a fourth power conversion unit that is a step-up type and a non-insulation type and is input with an output voltage of the rectification unit to obtain the DC input voltage.
(7) The electrical equipment device according to (6) above, in which
   the control unit stops a step-up operation of the fourth power conversion unit in the second mode.
(8) The electrical equipment device according to (6) or (7) above, in which
   the fourth power conversion unit includes a power factor correction (PFC) circuit.
(9) The electrical equipment device according to any one of (1) to (5) above, in which
   the input voltage generation unit includes a fourth power conversion unit that is a step-up type and a non-insulation type and is input with the commercial AC power supply to obtain the DC input voltage.
(10) The electrical equipment device according to (9) above, in which
   the fourth power conversion unit includes a totem-pole PFC circuit.
(11) The electrical equipment device according to (9) above, in which
   the fourth power conversion unit includes a dual boost PFC circuit.
(12) The electrical equipment device according to any one of (1) to (11) above, in which
   the first power conversion unit includes an LLC current resonant DC-DC converter or a flyback converter,
   the second power conversion unit includes an LLC current resonant DC-DC converter or a flyback converter, and the third power conversion unit includes a step-up DC-DC converter, a step-down DC-DC converter, or a step-up/down DC-DC converter.
(13) The electrical equipment device according to any one of (1) to (12) above, further including:
   a user operation unit that allows a user to perform an operation for changing load power of the first load unit.
(14) A display device including:
   a display unit;
   a load unit different from the display unit; and
   a power supply device, in which
   the power supply device includes:
   an input voltage generation unit configured be input with a commercial AC power supply to generate a DC input voltage;
   a first power conversion unit being of an insulation type and configured to be input with the DC input voltage to obtain a first power supply output of a DC voltage having a first value;
   a second power conversion unit being of an insulation type and configured to be input with the DC input voltage to obtain a second power supply output of a DC voltage having a second value different from the first value;
   a third power conversion unit being of a non-insulation type and configured to be input with the DC voltage having the second value to obtain a third power supply output of a DC voltage having the first value;
   a switching unit configured to selectively output the first power supply output or the third power supply output;
   a power supply output supply unit configured to supply a power supply output that is output from the switching unit to the display unit, and supply the second power supply output to the load unit; and
   a control unit configured to cause the switching unit to output the first power supply output in a first mode in which load power of the display unit is larger than a threshold, and cause the switching unit to output the third power supply output in a second mode in which load power of the display unit is equal to or less than the threshold.
(15) The display device according to (14), in which
   the display unit is a liquid crystal panel having a backlight or an organic electronic luminescent (EL) panel.
(16) The display device according to (14) or (15), further including:
   a user operation unit that allows a user to perform an operation for changing display luminance of the display unit, in which
   load power of the display unit changes in accordance with a change in the display luminance.
(17) A power supply device including:
   an input voltage generation unit configured be input with a commercial AC power supply to generate a DC input voltage;
   a first power conversion unit being of an insulation type and configured to be input with the DC input voltage to obtain a first power supply output of a DC voltage having a first value;
   a second power conversion unit being of an insulation type and configured to be input with the DC input voltage to obtain a second power supply output of a DC voltage having a second value different from the first value;
   a third power conversion unit being of a non-insulation type and configured to be input with the DC voltage having the second value to obtain a third power supply output of a DC voltage having the first value;
   a switching unit configured to selectively output the first power supply output or the third power supply output;
   a power supply output supply unit configured to supply a power supply output that is output from the switching unit to a first load unit, and supply the second power supply output to a second load unit; and
   a control unit configured to cause the switching unit to output the first power supply output in a first mode in which load power of the first load unit is larger than a threshold, and cause the switching unit to output the third power supply output in a second mode in which load power of the first load unit is equal to or less than the threshold.
(18) The power supply device according to (17) above, in which
the input voltage generation unit includes a rectification unit that rectifies the commercial AC power supply, and a fourth power conversion unit that is a step-up type and a non-insulation type and is input with an output voltage of the rectification unit to obtain the DC input voltage.
(19) The power supply device according to (17) above, in which
   the input voltage generation unit includes a fourth power conversion unit that is a step-up type and a non-insulation type and is input with the commercial AC power supply to obtain the DC input voltage.
(20) The power supply device according to any one of (17) to (19) above, in which
   the first power conversion unit includes an LLC current resonant DC-DC converter or a flyback converter,
   the second power conversion unit includes an LLC current resonant DC-DC converter or a flyback converter, and
   the third power conversion unit includes a step-up DC-DC converter, a step-down DC-DC converter, or a step-up/down DC-DC converter.

### REFERENCE SIGNS LIST

10 TV monitor
11 CPU
12 User operation unit
13 LED load unit
14 System load unit
20 Electrical equipment device
21 CPU
22 User operation unit
23 First load unit
24 Second load unit
100, 100A, 100B, 120 Power supply device
101 Rectifier circuit
102, 102B, 103, 104, 105 Power supply circuit
106 Switching circuit
107 Switching control unit

1. An electrical equipment device comprising:
a first load unit;
a second load unit; and
a power supply device, wherein
the power supply device includes:
an input voltage generation unit configured be input with a commercial alternating current (AC) power supply to generate a direct current (DC) input voltage;
a first power conversion unit being of an insulation type and configured to be input with the DC input voltage to obtain a first power supply output of a DC voltage having a first value;
a second power conversion unit being of an insulation type and configured to be input with the DC input voltage to obtain a second power supply output of a DC voltage having a second value different from the first value;
a third power conversion unit being of a non-insulation type and configured to be input with the DC voltage having the second value to obtain a third power supply output of a DC voltage having the first value;
a switching unit configured to selectively output the first power supply output or the third power supply output;
a power supply output supply unit configured to supply a power supply output that is output from the switching unit to the first load unit, and supply the second power supply output to the second load unit; and
a control unit configured to cause the switching unit to output the first power supply output in a first mode in which load power of the first load unit is larger than a threshold, and cause the switching unit to output the third power supply output in a second mode in which load power of the first load unit is equal to or less than the threshold.

2. The electrical equipment device according to claim 1, wherein
the control unit stops the third power conversion unit in the first mode, and stops the first power conversion unit in the second mode.

3. The electrical equipment device according to claim 2, wherein
the switching unit has a configuration in which a switching element or a diode is disposed on each of a path between an output side and the first power conversion unit and a path between the output side and the third power conversion unit.

4. The electrical equipment device according to claim 1, wherein
the control unit stops the first power conversion unit in the second mode.

5. The electrical equipment device according to claim 4, wherein
the switching unit has a configuration in which two metal-oxide-semiconductor field-effect transistors (MOSFETs) are disposed in series on a path between an output side and the third power conversion unit such that directions of parasitic diodes are opposite to each other.

6. The electrical equipment device according to claim 1, wherein
the input voltage generation unit includes a rectification unit that rectifies the commercial AC power supply, and a fourth power conversion unit that is a step-up type and a non-insulation type and is input with an output voltage of the rectification unit to obtain the DC input voltage.

7. The electrical equipment device according to claim 6, wherein
the control unit stops a step-up operation of the fourth power conversion unit in the second mode.

8. The electrical equipment device according to claim 6, wherein
the fourth power conversion unit includes a power factor correction (PFC) circuit.

9. The electrical equipment device according to claim 1, wherein
the input voltage generation unit includes a fourth power conversion unit that is a step-up type and a non-insulation type and is input with the commercial AC power supply to obtain the DC input voltage.

10. The electrical equipment device according to claim 9, wherein
the fourth power conversion unit includes a totem-pole PFC circuit.

11. The electrical equipment device according to claim 9, wherein
the fourth power conversion unit includes a dual boost PFC circuit.

12. The electrical equipment device according to claim 1, wherein
the first power conversion unit includes an LLC current resonant DC-DC converter or a flyback converter,
the second power conversion unit includes an LLC current resonant DC-DC converter or a flyback converter, and
the third power conversion unit includes a step-up DC-DC converter, a step-down DC-DC converter, or a step-up/down DC-DC converter.

13. The electrical equipment device according to claim 1, further comprising
a user operation unit that allows a user to perform an operation for changing load power of the first load unit.

14. A display device comprising:
a display unit;
a load unit different from the display unit; and
a power supply device, wherein
the power supply device includes:
an input voltage generation unit configured be input with a commercial AC power supply to generate a DC input voltage;
a first power conversion unit being of an insulation type and configured to be input with the DC input voltage to obtain a first power supply output of a DC voltage having a first value;
a second power conversion unit being of an insulation type and configured to be input with the DC input voltage to obtain a second power supply output of a DC voltage having a second value different from the first value;
a third power conversion unit being of a non-insulation type and configured to be input with the DC voltage having the second value to obtain a third power supply output of a DC voltage having the first value;
a switching unit configured to selectively output the first power supply output or the third power supply output;
a power supply output supply unit configured to supply a power supply output that is output from the switching unit to the display unit, and supply the second power supply output to the load unit; and
a control unit configured to cause the switching unit to output the first power supply output in a first mode in which load power of the display unit is larger than a threshold, and cause the switching unit to output the third power supply output in a second mode in which load power of the display unit is equal to or less than the threshold.

15. The display device according to claim 14, wherein
the display unit includes a liquid crystal panel having a backlight or an organic EL panel.

16. The display device according to claim 14, further comprising:
a user operation unit that allows a user to perform an operation for changing display luminance of the display unit, wherein
load power of the display unit changes in accordance with a change in the display luminance.

17. A power supply device comprising:
an input voltage generation unit configured be input with a commercial AC power supply to generate a DC input voltage;
a first power conversion unit being of an insulation type and configured to be input with the DC input voltage to obtain a first power supply output of a DC voltage having a first value;
a second power conversion unit being of an insulation type and configured to be input with the DC input voltage to obtain a second power supply output of a DC voltage having a second value different from the first value;
a third power conversion unit being of a non-insulation type and configured to be input with the DC voltage having the second value to obtain a third power supply output of a DC voltage having the first value;
a switching unit configured to selectively output the first power supply output or the third power supply output;
a power supply output supply unit configured to supply a power supply output that is output from the switching unit to a first load unit, and supply the second power supply output to a second load unit; and
a control unit configured to cause the switching unit to output the first power supply output in a first mode in which load power of the first load unit is larger than a threshold, and cause the switching unit to output the third power supply output in a second mode in which load power of the first load unit is equal to or less than the threshold.

18. The power supply device according to claim 17, wherein
the input voltage generation unit includes a rectification unit that rectifies the commercial AC power supply, and a fourth power conversion unit that is a step-up type and a non-insulation type and is input with an output voltage of the rectification unit to obtain the DC input voltage.

19. The power supply device according to claim 17, wherein
the input voltage generation unit includes a fourth power conversion unit that is a step-up type and a non-insulation type and is input with the commercial AC power supply to obtain the DC input voltage.

20. The power supply device according to claim 17, wherein
the first power conversion unit includes an LLC current resonant DC-DC converter or a flyback converter,
the second power conversion unit includes an LLC current resonant DC-DC converter or a flyback converter, and
the third power conversion unit includes a step-up DC-DC converter, a step-down DC-DC converter, or a step-up/down DC-DC converter.
